(19) United States
(12) Patent Application Publication
(10) Pub. No.: US 2007/0132709 A1
(43) Pub. Date: Jun. 14, 2007

(54) LIQUID CRYSTAL DISPLAY DEVICE AND METHOD FOR DRIVING THE SAME

(75) Inventor: Seiji KAWAGUCHI, Hirakata-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd, Tokyo (JP)

(21) Appl. No.: 11/609,290

(22) Filed: Dec. 11, 2006

(30) Foreign Application Priority Data
Dec. 12, 2005 (JP) 2005-358175
Dec. 12, 2005 (JP) 2005-358186
Jul. 11, 2006 (JP) 2006-190697

(51) Int. Cl. G09G 3/36

(52) U.S. Cl. 345/102

(57) ABSTRACT

Occurrence of insufficient writing to a liquid crystal display element is prevented in the liquid crystal display device which causes a backlight to illuminate only while the liquid crystal display element responds to the display data. A liquid crystal display device has a liquid crystal display panel using an OCB mode liquid crystal, divides a field period into a black writing period, a display data writing period, and a display data hold period, writes black data for preventing transferring from the bend alignment to the spray alignment in the black writing period, writes display data in the display data writing period, and lights a backlight during a part of the display data hold period, wherein a gate driver makes periods during each of which each of gate signals corresponding to each of the scan lines are turned on are same to each other when a source driver writes the display data in the liquid crystal display element, and makes periods during each of which each of gate signals corresponding to each of the scan lines are turned on longer than a period during which display data is written for a line when the source driver writes black data for preventing transferring from the bend alignment to the spray alignment.

### CROSS-REFERENCE TO RELATED APPLICATIONS

This application claims priority to Japanese Patent Application Nos. 2005-358175, filed in the Japanese Patent Office on Dec. 12, 2005, 2005-358186, filed in the Japanese Patent Office on Dec. 12, 2005, and 2006-190697, filed in the Japanese Patent Office on Jul. 11, 2006, the entire contents of each are hereby incorporated herein by reference.

### BACKGROUND OF THE INVENTION

1. Field of the Invention

The present invention relates to a liquid crystal display device using an OCB mode liquid crystal and a method for driving the liquid crystal display device.

2. Description of the Related Art

Liquid crystal display devices are thin and light and are expected to replace conventional cathode-ray tubes. Thus, the applications of liquid crystal display devices have been increasingly expanded. However, currently popular TN (Twisted Nematic) oriented liquid crystal display panels offer small view angles and low response speeds and may show unwanted trails during motion picture display. These liquid crystal display panels thus offer lower image quality than cathode-ray tubes.

In recent years, increasingly extensive use has been made of a liquid crystal display device comprising a liquid crystal display element in an OCB (Optically Compensated Birefringence) mode characterized by a high response speed and a large view angle. The liquid crystal in this liquid crystal display device is bent for visual compensations. This is further combined with an optical phase compensation film to provide a larger view angle.

FIGS. 26(A) to 26(C) are sectional views schematically showing how liquid crystal molecules in the OCB mode liquid crystal display element are oriented. FIGS. 26(A) and 26(B) are sectional views showing a voltage application state. FIG. 26(C) is a sectional view showing a voltage non-application state.

A Nematic liquid crystal, shown as liquid crystal molecules 62 in FIG. 26(A) and others, is injected between glass substrates 61 of a liquid crystal display panel constituting the liquid crystal display device using the OCB mode liquid crystal display element. The orientation of the liquid crystal in the voltage non-application state is called a spray state 63. When the liquid crystal display device using the OCB mode liquid crystal display element is powered on, driving called transition-driving needs to be executed. The transition driving involves applying a relatively high voltage of about 20 to 25 V to the liquid crystal layer when the liquid crystal display device is powered on, to change the spray state 63, shown in FIG. 26(C), to bend states 64a and 64b shown in FIGS. 26(A) and 26(B). The use of the bend states 64a and 64b for display is characteristic of the liquid crystal display device using the OCB mode liquid crystal display element. The voltage is increased or reduced to change the bend state and thus the transmittance of the panel.

The bend state 64a shown in FIG. 26(A) corresponds to white display. The bend state 64b shown in FIG. 26(B) corresponds to black display.

With the liquid crystal display device using the OCB mode liquid crystal display element, when a voltage of at most 2 V continuously applied to the liquid crystal display panel, the orientation of the liquid crystal gradually changes from the bend state 64a or 64b to the spray state 63 (this change is referred to as transferring from the bend alignment to the spray alignment). To prevent such transferring from the bend alignment to the spray alignment, the liquid crystal display device using the OCB mode liquid crystal display element executes driving called the driving to prevent transferring from the bend alignment to the spray alignment.

Specifically, for a liquid crystal display device in a normally white mode in which white display is provided during application of a relatively low voltage, while black display is provided during application of a relatively high voltage, the driving to prevent transferring from the bend alignment to the spray alignment applies a voltage corresponding to black in addition to a video signal periodically displayed at each pixel to prevent transferring from the bend alignment to the spray alignment. The driving to prevent transferring from the bend alignment to the spray alignment includes double speed conversion involving alternate performance of an operation of applying a voltage corresponding to black to each pixel in order to prevent transferring from the bend alignment to the spray alignment and an operation of applying a voltage corresponding to a video signal to the pixel (see, for example, Japanese Patent Laid-Open No. 2003-280617).

Accordingly, with the liquid crystal display device using the conventional OCB mode liquid crystal display element, a period during which a video for a frame (or a field) is displayed includes a display period during which the voltage corresponding to the video signal is applied to each pixel and a black insertion period during which the voltage corresponding to black is applied to the pixel in order to prevent transferring from the bend alignment to the spray alignment.

FIG. 27 shows a configuration of a liquid crystal display device using a conventional OCB mode liquid crystal display element.

The liquid crystal display device includes a liquid crystal display panel 110, a backlight 111, a source driver 112, a gate driver 113, a controller 114, an input power source 116, and a liquid crystal driving voltage generating circuit 117.

The liquid crystal display panel 110 has signal lines and scan lines arranged in a matrix, with OCB mode liquid crystal display elements each provided at the intersection point between each pair of signal and scan lines.

The backlight 111 is arranged at the backside of the liquid crystal display panel 110 for illuminating the liquid crystal display panel 110 with a plurality of cold cathodes.

The input power source 116 supplies power to the backlight 111, the controller 114 and the liquid crystal driving voltage generating circuit 117. The liquid crystal driving voltage generating circuit 117 adjusts a voltage to be supplied to the source driver 112 and the gate driver 113 according to the timing at which display data is displayed on the liquid crystal display panel 110.

The gate driver 113 supplies a gate signal to a scan line of the liquid crystal display panel 110. The source driver 112 supplies a voltage according to a display signal to a signal line of the liquid crystal display panel 110.

The controller 114 comprises a signal processing section 121, a line memory 122, and a timing control section 123. The source driver 112 comprises a D/A converting section 124 and a shift register 125.

Description will be given below of a conventional liquid crystal display device operation.

When the power source of the liquid crystal display device is turned on, a liquid crystal layer of the liquid crystal display panel 110 is still in a spray state 63 as shown in FIG. 26(C). Thus, the state needs to be transitioned from the spray state 63 to the bend state 64a of FIG. 26(A) or the bend state 64b of FIG. 26(B). When the power source of the liquid crystal display device is turned on, it executes transition driving to transit the state of the liquid crystal layer from the spray state to the bend state. That is to say, the source driver 112 applies a voltage from 20 V to 25 V to the signal line as a voltage for the transition driving so that the voltage between pixel electrodes and common electrodes becomes higher than a voltage for displaying a video from 20 V to 25 V for a predetermined time period. As a voltage for transition driving is applied to the liquid crystal layer for a predetermined time period, the liquid crystal layer of the liquid crystal display panel 110 transits from the spray state to the bend state so that a display operation of the liquid crystal display device can be realized.

The transition driving completes and the display operation is enabled as mentioned above, whereby the liquid crystal display device starts the display operation.

As a video signal of RGB data is input into the signal processing section 121, the signal processing section 121 executes gray scale correction or gamma correction on the input video signal and also converts the video signal so that black data for black insertion comes in the first part of a horizontal period and double-speed video signal comes in the latter part of the horizontal period for each data in the horizontal period, and stores the result in a line memory 122.

Then, the timing control section 123 of the controller 114 transfers data on the pixels in a line stored in the line memory 122 to the shift register 125 of the source driver 112, when a display signal included in the video signal starts to be input.

The timing control section 123 of the controller 114 sends controlling signals to each of the gate driver 113 and the source driver 112 according to the video signal input from outside when the liquid crystal display device executes the display operation. As a result, the gate driver 113 applies a scan signal voltage to each of the scan lines to sequentially turn on a switching element of each pixel.

During the display period, the source driver 112 applies a voltage according to the video signal to pixel electrodes of each pixel through a signal line when the gate driver 113 applies a scan signal voltage to each of the scan lines. Accordingly, liquid crystal molecules 62 of the liquid crystal display panel 110 are modulated so that transmittance of light outputted from the backlight 111 changes. As a result, a user sees a picture corresponding to the video signal.

During a black insertion period, the source driver 112 applies a voltage corresponding to black to pixel electrodes of each pixel through a signal line when the gate driver 113 applies a scan signal voltage to each scan line. As a result, the liquid crystal molecules 62 of the liquid crystal display panel 110 are modulated and transmittance of light outputted from the backlight 111 changes. As a result, a user sees a video in black.

FIG. 28 shows an example of a timing chart of a video signal, a double-speed signal, and a gate pulse in the driving to prevent transferring from the bend alignment to the spray alignment by double-speed conversion in a conventional liquid crystal display device shown in FIG. 27.

A video signal input as RGB data is stored in a shift register 125 of a source driver 112 so that for each horizontal period (1H period), data on a black gray level for preventing transferring from the bend alignment to the spray alignment is stored in the first part of 1H period and the display data constituting the video signal converted into a double speed is stored in the latter part of the 1H period respectively. A shaded part in FIG. 28 indicates the black gray level data for preventing transferring from the bend alignment to the spray alignment.

For each 1H period, data on the pixels in a line are sequentially input to the shift register 125. The source driver 112 simultaneously outputs data on the pixels in a line. Consequently, as shown in FIG. 28, the data is output from the source driver 112 at a 1H period later than the input video signal.

G1 to G10 in FIG. 28 denote gate signals output from the gate driver 113 to each of the gate lines. A reference character shown on the right of each gate signal denotes display data or black insertion data (B), which is written in an image cell when the corresponding gate signal becomes high.

When display data S1 is output from the source driver, the gate signal on agate line G1 becomes high. The display signal S1 is written in an image cell on the gate line G1. Then, when black insertion data inserted between the display data S1 and display data S2 is output from the source driver, a gate signal on a gate line G7 becomes high. The black insertion data is written in an image cell on the gate line G7. Then, when display data S2 is output from the source driver, a gate signal on a gate line G2 becomes high. The display signal S2 is written in an image cell on the gate line G2. Then, when black insertion data inserted between the display data S2 and display data S3 is outputted from the source driver, a gate signal on a gate line G8 becomes high. The black insertion data is written in the image cell on the gate line G8. A similar process is subsequently executed so that display data or black insertion data is written in each image cell when a gate signal on the corresponding gate line becomes high.

Thus, each of the gate lines G1 to G10 is selected twice for each field period. Display data and black insertion data are written once to the image cell on each of the gate lines G1 to G10. Consequently, the driving to prevent transferring from the bend alignment to the spray alignment can be achieved that writes display data, while periodically writing black insertion data.

As a result, in the example shown in FIG. 28, the ratio of a video display period T1 to a black insertion period T2 is set at 9:11. The ratio of black data as inserted was adjusted by adjusting the ratio of the video display period T1 to the black insertion period T2 by varying timings for the gate pulse for writing display data and the gate pulse for writing black insertion data of a gate signal of each of the gate lines G1 to G10.

As shown in FIG. 28, as display data is sequentially written in each image cell on each of the gate lines G1 to G10 for whole periods of a whole field period, the backlight 111 illuminates the liquid crystal display panel 110 by alternatively repeating lighting and extinction for the whole field period. The brightness at which the backlight 111 controls illuminate the liquid crystal display panel 110 is controlled by adjusting a ratio between lighting and extinction using a PWM (Pulse Wave Modulation) control.

Therefore, in the conventional method, the backlight 111 also illuminates black data written for preventing transferring from the bend alignment to the spray alignment to be displayed with display data.

Recently, since an OCB mode liquid crystal display element, which responds faster, has been developed and a cold cathode-ray tube in short afterglow type has also been developed, it has also been realized that a video can be displayed in a method for causing a backlight to illuminate only while the liquid crystal display element responds to the display data to improve motion picture quality.

FIG. 29 shows a configuration of a liquid crystal display device for implementing a method for causing a backlight to illuminate only while the liquid crystal display element responds to the display data. The same components as those in the liquid crystal display device shown in FIG. 27 are denoted by the same reference numerals.

The configuration of the liquid crystal display device of FIG. 29 is different from that of the liquid crystal display device show in FIG. 27 in that the line memory 122 is deleted and the frame memory 115 is added. It is also different from the liquid crystal display device of FIG. 27 in a controlling method of a timing control section 133 of the controller 114 and in that it controls ON/OFF of the backlight 130.

FIG. 30 shows a timing chart for illustrating an operation to implement a method for causing a backlight to illuminate only while the liquid crystal display element responds to display data in the liquid crystal display device shown in FIG. 29.

A period of a field (a frame) of writing to each of the liquid crystal display element is divided into a black writing period, a video writing period and a video HOLD period. The black data for preventing transferring from the bend alignment to the spray alignment is written during the black writing period and display data is written during the video writing period.

Reference characters G1 to G7 of FIG. 30 show gate signals output from the gate driver 113 onto each of the gate lines. A reference character shown on the right of each gate signals denotes display data or black insertion data (B), which is written in an image cell when the corresponding gate signal becomes high. A sign (+, −) shown in each period for writing pixels of FIG. 30 indicates a polarity of a voltage supplied when data is written in the liquid crystal display element. Here, the polarity of a writing voltage to the liquid crystal display element is reversed for each field.

A gate pulse is serially generated on each of the scan line and black data for preventing transferring from the bend alignment to the spray alignment is written in the black writing period. Then, a gate pulse is serially generated on each of the scan line and the display data in an immediately previous field stored in the frame memory 115 is written during the video writing period. Here, a width of a gate pulse generated as black data is written in the black writing period is the same pulse width as that generated when the display data is written during the video writing period.

Then, the timing control section 133 controls ON/OFF of the backlight 130 so that each of the gate signals G1 to G7 is turned off during the video HOLD period and the backlight 130 lights during a period after all the liquid crystal display elements respond and before the next black data is written. In the case of FIG. 30, the backlight 130 is controlled to light for the last 25% of a field period (a Pu period).

In the case of FIG. 28, the gate pulse for writing black data during the first part of the period and the gate pulse for writing display data during the latter part of the period were generated for each period, respectively. Display data and black data for a field were written for each 1H period through a field period. That means that a 50% period of a field period is used for writing each of the display data and the black data for a field.

In the case of FIG. 30, a black writing period for writing black data for a field is 25% and a video writing period for writing display data for a field is 20%. The periods are shorter than those in FIG. 28, respectively. As the black data and the display data are written in the corresponding liquid crystal display element on each scan line in order during respective periods, the gate pulse width is shorter in FIG. 30 than in the FIG. 28.

A method for lighting the backlight 130 only while the liquid crystal display element responds to the display data in this manner can be realized by using a fast responding OCB mode liquid crystal display element and a fast responding backlight such as a short afterglow cold cathode tube or the like.

With such controlling, impulse type video display can be implemented with a fine motion picture quality by using the OCB mode liquid crystal display element. As the backlight 130 is put off while the liquid crystal display element responds to the black data written in the black writing period, the contrast can be improved and the power consumption can be reduced.

There is a problem, however, in that insufficient writing to the liquid crystal display element is apt to occur when a voltage corresponding to black data to be inserted for preventing transferring from the bend alignment to the spray alignment is supplied with a method for causing a backlight to light only while the liquid crystal display element responds to the display data as described in FIG. 29 and FIG. 30. The temperature differs among the liquid crystal display panels. Lowering of the temperature below a certain temperature causes that phenomenon. If the panel has a low temperature, there is another problem in that the contrast lowers due to insufficient writing of black data for preventing transferring from the bend alignment to the spray alignment to the liquid crystal display element.

If the panel has a high temperature, there is a problem in transferring from the bend alignment to the spray alignment of the liquid crystal display element occurs.

The conventional method for causing the backlight to illuminate only while the liquid crystal display element responds to the display data has a problem that occurs when the temperature of the liquid crystal display element lowers below a certain temperature and a problem that occurs when the temperature of the liquid crystal display element rises above another certain temperature.

First, description will be given of how the problem occurs when the temperature of the liquid crystal display element lowers below a certain temperature.

A voltage supplied when the black data inserted for preventing transferring from the bend alignment to the spray alignment is written is higher than that supplied when the display data is written. When a high voltage is supplied with a reversed polarity data is harder to be written in the liquid crystal display element than in the case where the polarity is not reversed or where a low voltage is supplied even with a reversed polarity.

In such a method for causing the backlight to illuminate only while the liquid crystal display element responds to the display data as shown in FIG. 30, a gate pulse width for writing black data is narrower than in the conventional driving method as shown in FIG. 28 and the black data for the next preventing transferring from the bend alignment to the spray alignment is written with the polarity of the voltage supplied to the display data immediately before reversed. That may cause insufficient writing to the liquid crystal display element when the black data is written. The lower the temperature, the longer the time required for charging the liquid crystal display element. Thus, the problem occurs when the temperature is below a certain temperature.

FIG. 31 shows a timing chart for illustrating an operation when insufficient writing to the liquid crystal display element occurs in the method for causing the backlight to illuminate only while the liquid crystal display element responds to the display data. The figure shows a state of a voltage charged to each of the liquid crystal display elements when white display is provided and when black display is provided under a low temperature.

A voltage is supplied to the liquid crystal display element only while a gate pulse is occurring. Thus, if the liquid crystal display element is not charged to a required voltage value while the gate pulse is occurring, insufficient writing occurs.

A “predetermined voltage of black insertion data” shown in FIG. 31 means the voltage which should be written in the liquid crystal display element for the black data to be inserted for preventing transferring from the bend alignment to the spray alignment. When the liquid crystal display element is charged to a predetermined voltage value for the black data, transferring from the bend alignment to the spray alignment can be prevented.

When white display that is difficult to be written in the liquid crystal display element is provided, the liquid crystal display element is not charged to the predetermined voltage value while a gate pulse for a black writing period occurs, resulting in transferring from the bend alignment to the spray alignment due to insufficient writing as shown in “when white display is provided” of FIG. 31.

Although the phenomenon transferring from the bend alignment to the spray alignment seldom occurs under a further lower temperature, the liquid crystal display element is not charged to a voltage corresponding to black for the display data when black display is provided, lowering the contrast.

A “predetermined voltage of display black data” shown in FIG. 31 means a voltage that should be written in the liquid crystal display element for the black data to be displayed. When the liquid crystal display element is charged to the predetermined voltage value for the display black data, black is normally displayed.

If black display is provided at a low temperature, an electric potential does not sufficiently rise due to insufficient writing to the liquid crystal display element when black data for preventing transferring from the bend alignment to the spray alignment is written during the black writing period as shown in “black display at low temperature” in FIG. 31. Accordingly, when black data for display data is written during a following video writing period, the liquid crystal display element is not charged to a predetermined voltage value for the display black data. Consequently, black is displayed in a half tone, lowering the contrast.

Description will be given below of how the problem due to the high temperature of the liquid crystal display element occurs.

When the liquid crystal display element has a high temperature, the liquid crystal molecules are apt to move and transferring from the bend alignment to the spray alignment from the bend state to the spray state is apt to occur. FIG. 32 is a graph showing relationship between the surface temperature of the liquid crystal display panel 110 and the black insertion ratio, which is obtained as relationship between the surface temperature of the liquid crystal display panel 110 and an appropriate black insertion ratio is studied in advance to identify the black insertion ratio that can prevent transferring from the bend alignment to the spray alignment to stably keep the bend state. The black insertion ratio means a proportion of a period, during which black data is written and kept in the liquid crystal display element, to the whole of the display periods. Therefore, transferring from the bend alignment to the spray alignment can be prevented even when white display is provided, if only the black data is inserted so that a period for the black data to be written and kept in the liquid crystal display element is more than the black insertion ratio shown in FIG. 32.

On the other hand, in the liquid crystal display device shown in FIG. 29, display data is sequentially written in the liquid crystal display element on each of the scan lines during the video writing period as shown in FIG. 30. Accordingly, each liquid crystal display element on different scan lines responds to the written display data at a different timing.

FIG. 33 shows a timing chart indicating how each liquid crystal display element responds at that moment.

Each liquid crystal display element is kept in a state that black data is written during a period until the next display data is written for the black data that is written for preventing transferring from the bend alignment to the spray alignment during the black writing period. As writing of black data and writing of display data to each liquid crystal display element are sequentially performed in synchronization with each other, a period during which black data is kept being written is the same for each liquid crystal display element as shown in FIG. 33. The period has the same length as that of the black writing period in a field period. As the black writing period is 25% of a field period in the liquid crystal display device of FIG. 29, the black insertion ratio here is 25%.

Based on the relationship between a surface temperature of the liquid crystal display panel 110 and the black insertion ratio shown in FIG. 32, transferring from the bend alignment to the spray alignment occurs when the surface temperature of the liquid crystal display panel 110 rises to about 45 degrees Celsius or more with the black insertion ratio being 25%.

The present invention is for solving the above mentioned conventional problems. The present invention intends to provide an liquid crystal display device, which can reduce insufficient writing to the liquid crystal display element which occurs when a voltage corresponding to black data to be inserted for preventing transferring from the bend alignment to the spray alignment is supplied in a display method for causing a backlight to illuminate only while the liquid crystal display element responds to the display data, and a method for driving the liquid crystal display device.

Another present invention is for solving the above mentioned conventional problems. The present invention intends to provide a liquid crystal display device, which can prevent occurrence transferring from the bend alignment to the spray alignment even under a high temperature in a method for causing a backlight to illuminate only while the liquid crystal display element responds to display data, and a driving method of the liquid crystal display device.

### SUMMARY OF THE INVENTION

The 1^{st} aspect of the present invention is a liquid crystal display device comprising:

a liquid crystal display panel having signal lines and scan lines arranged in a matrix and liquid crystal display elements using an OCB mode liquid crystal provided at intersection points between said signal lines and scan lines;

a frame memory which temporally stores display data for at least one immediately previous field or frame;

a gate driver which supplies a gate signal to said scan line;

wherein one field or one frame has in its period, in order, a black writing period, a display data writing period and a display data hold period;

a source driver which supplies a voltage corresponding to black data to said signal line during said black writing period, and supplies a voltage corresponding to the display data in a previous field or frame temporally stored in said frame memory to said signal line during said display data writing period; and

a backlight arranged at the backside of said liquid crystal display panel for illuminating said liquid crystal display panel only during a part of said display data hold period during which said gate signal is kept turned off; wherein

said gate driver operates so that when said source driver supplies a voltage corresponding to said black data during said black writing period, a period during which each of said gate signals to be supplied to each of said scan lines is turned on is longer than one line writing period during which said source driver writes display data for one line.

The 2^{nd} aspect of the present invention is the liquid crystal display device according to the 1^{st} aspect of the present invention, wherein

the period during which said gate driver turns on each of said gate signals to be supplied to each of said scan lines when said source driver supplies a voltage corresponding to said black data during said black writing period is a period during which said liquid crystal display element can be charged to at least a predetermined voltage value required to avoid transferring from the bend alignment to the spray alignment; and

said gate driver sequentially turns on each of said gate signals of each of said scan lines during said black writing period so that a period after a voltage corresponding to said black data is supplied during said black writing period for each of the liquid crystal display elements until a voltage corresponding to said display data is supplied during said display data writing period is sufficient for said liquid crystal display element to be charged to a predetermined voltage to execute black insertion and also at least a predetermined period during which transferring from the bend alignment to the spray alignment does not occur to any of said liquid crystal display element.

The 3^{rd} aspect of the present invention is the liquid crystal display device according to the 1^{st} aspect of the present invention, wherein

the period during which said gate driver turns on each of said gate signals to be supplied to each of said scan lines when said source driver supplies a voltage corresponding to said black data during said black writing period is a period during which said liquid crystal display element can be charged to at least a predetermined voltage value required to avoid transferring from the bend alignment to the spray alignment; and

said gate driver turns on each of said gate singles of each of said scan lines during said black writing period at a time so that a period after a voltage corresponding to said black data is supplied to each of said liquid crystal display elements during said black writing period until a voltage corresponding to said display data is supplied to each of said liquid crystal display elements during said display data writing period is sufficient for said liquid crystal display element to be charged to a predetermined voltage to execute black insertion and also at least a predetermined period during which transferring from the bend alignment to the spray alignment does not occur to any of said liquid crystal display element.

The 4^{th} aspect of the present invention is the liquid crystal display device according to the 1^{st} aspect of the present invention, wherein

said gate driver operates so that a period during which it turns on each of said gates signals to be supplied to each of said scan lines during said black writing period is longer than said period during which it turns on each of said gate signals to be supplied to each of said scan lines when a voltage corresponding to said display data is supplied, only in the case where a polarity of a voltage supplied by said source driver in corresponding to said black data during said black writing period is reversed from a polarity of a voltage supplied by said source driver in association with said display data during said display data wring period immediately therebefore.

The 5^{th} aspect of the present invention The liquid crystal display device according to the 1^{st} aspect of the present invention, wherein

said gate driver supplies each of said gate signals so that the total of the periods during which each of said gate signals for each of said scan lines is turned on in said display data writing period provided in a period of said one field or one frame is longer than said one line writing period.

The 6^{th} aspect of the present invention The liquid crystal display device according to the 1^{st} aspect of the present invention, wherein

said gate driver turns on each of said gate signals to be supplied to each of said scan lines once for said display data writing period provided in a period of said one field or one frame; and

said period during which each of said gate signals is turned on once is longer than said one line writing period.

The 7^{th} aspect of the present invention is the liquid crystal display device according to the 5^{th} aspect of the present invention, wherein

said gate driver executes an operation for sequentially turning on each of said gate signals to be supplied to each of said scan lines for a plurality of times during said display data writing period provided in a period of said one field or frame; and

any one period among those during which each of said gate signals is turned on for a plurality of times is longer than said one line writing period or longer.

The 8^{th} aspect of the present invention is the liquid crystal display device according to the 7^{th} aspect of the present invention, wherein

during said display data writing period provided in a period of said one field or frame, a period during which said gate driver turns on each of said gate signals for the last time among a plurality of periods during which each of said gate signals to be supplied to each of said scan lines is turned on is as long as said one line writing period.

The 9^{th} aspect of the present invention is the liquid crystal display device according to the 7^{th} aspect of the present invention, wherein

said source driver supplies a voltage corresponding to the same display data for each line to said signal lines for a plurality of times in each period during which said gate driver turns on each of said gate signals for a plurality of times during said display data writing period provided in a period of said one field or frame.

The 10^{th} aspect of the present invention is a method for driving a liquid crystal display device, wherein said liquid crystal display device comprises:

a liquid crystal display panel having signal lines and scan lines arranged in a matrix and liquid crystal display elements using an OCB mode liquid crystal provided at intersection points between said signal lines and scan lines;

a frame memory which temporally stores display data for at least one immediately previous field or frame;

a gate driver which supplies a gate signal to said scan line;

wherein one field or one frame has in its period, in order, a black writing period, a display data writing period and a display data hold period;

a source driver which supplies a voltage corresponding to black data to said signals line during said black writing period, and supplies a voltage corresponding to the display data in a previous field or frame temporally stored in said frame memory to said signal line during said display data writing period; and

a backlight arranged at the backside of said liquid crystal display panel for illuminating said liquid crystal display panel only during a part of said display data hold period during which said gate signal is kept turned off; wherein

when said source driver supplies a voltage corresponding to said black data during said black writing period, a period during which each of said gate signals to be supplied to each of said scan lines is turned on is longer than a period during which said source driver writes display data for one line.

The 11^{th} aspect of the present invention is a liquid crystal display device comprising:

a liquid crystal display panel having signal lines and scan lines arranged in a matrix and liquid crystal display elements using an OCB mode liquid crystal provided at intersection points between said signal lines and scan lines;

a frame memory which temporally stores display data for at least one immediately previous field or frame;

a gate driver which supplies a gate signal to said scan line;

wherein one field or one frame has in its period, in order, a black writing period, a display data writing period and a display data hold period;

a source driver which supplies a voltage corresponding to black data to said signal line during said black writing period, and supplies a voltage corresponding to the display data in a previous field or frame temporally stored in said frame memory to said signal line during said display data writing period;

a backlight arranged at the backside of said liquid crystal display panel for illuminating said liquid crystal display panel only during a backlight illuminating period, which is a part of said display data hold period during which said gate signal is kept turned off;

a temperature detecting unit for detecting a temperature of said liquid crystal display panel; and

a timing control unit for controlling, based on the detected temperature of said liquid crystal display panel, black data writing start timing for said source driver to start to supply to said signal line a voltage corresponding to said black data during said black writing period and display data writing start timing for said source driver to start to supply to said signal line a voltage corresponding to said display data during said display data writing period;

wherein, when the temperature of said liquid crystal display panel is a predetermined temperature or more, said timing control unit controls said display data writing start timing to gradually or stepwise delays more relative to said black data writing start timing as the temperature of said liquid crystal display panel is higher.

The 12^{th} aspect of the present invention is the liquid crystal display device according to the 11^{th} aspect of the present invention, wherein

a period during which said black data is written in and saved in each of said liquid crystal display elements when said timing control unit controls said display data writing start timing is a period during which transferring from the bend alignment to the spray alignment does not occur.

The 13^{th} aspect of the present invention is the liquid crystal display device according to the 11^{th} aspect of the present invention, comprising:

a black insertion ratio table in which a temperature of said liquid crystal display panel and an insertion ratio of said black data required to prevent transferring from the bend alignment to the spray alignment from being occurred at each temperature are associated with each other; wherein

said timing control unit obtains an insertion ratio of said black data required at the detected temperature of said liquid crystal display panel by referring to said black insertion ratio table and decides said display data writing start timing from said obtained insertion ratio.

The 14^{th} aspect of the present invention is the liquid crystal display device according to the 11^{th} aspect of the present invention, further comprising:

a backlight control unit which controls said backlight to light only during said backlight illuminating period, and controls a timing to start lighting of a backlight to gradually or stepwise delay more as the detected temperature of said liquid crystal display panel is higher when the temperature of said liquid crystal display panel is at said predetermined temperature or more and in a predetermined temperature range.

The 15^{th} aspect of the present invention is the liquid crystal display data according to the 14 ^{th} aspect of the present invention, wherein

said backlight control unit makes said timing to start lighting of a backlight a predetermined lighting timing which is decided in advance when the detected temperature of said liquid crystal display panel is lower than a temperature in said predetermined temperature range.

The 16^{th} aspect of the present invention is the liquid crystal display device according to the 14 ^{th} aspect of the present invention, comprising:

a lighting start timing decision table which associates a temperature of said liquid crystal display panel and a timing to start lighting of said backlight required at the temperature; wherein

said backlight control unit obtains said timing to start lighting of a backlight required at the detected temperature of said liquid crystal display panel by using said lighting start timing decision table and starts lighting of said backlight after said obtained timing to start lighting of a backlight.

The 17^{th} aspect of the present invention is the liquid crystal display device according to The 16^{th} aspect of the present invention, wherein

said timing to start lighting of a backlight required at said temperature is a timing at which a response voltage value of all of said liquid crystal display elements are 90% or more after a voltage corresponding to said display data is supplied to said signal lines.

The 18^{th} aspect of the present invention is the liquid crystal display device according to the 14 ^{th} aspect of the present invention, wherein

said backlight is a LED, and

said backlight control unit controls a current of said backlight to increase so that the backlight lights brighter when said timing to start lighting of a backlight delays.

The 19^{th} aspect of the present invention is the liquid crystal display device according to the 18^{th} aspect of the present invention, wherein

said backlight control unit controls an applied voltage to said backlight to increase so that the current of the backlight increases.

The 20^{th} aspect of the present invention is a method for driving a liquid crystal display device, wherein said liquid crystal display device comprises:

a liquid crystal display panel having signal lines and scan lines arranged in a matrix and liquid crystal display elements using an OCB mode liquid crystal provided at intersection points between said signal lines and scan lines;

a frame memory which temporally stores display data for at least one immediately previous field or frame;

a gate driver which supplies a gate signal to said scan line;

wherein one field or one frame has in its period, in order, a black writing period, a display data writing period and a display data hold period;

a source driver which supplies a voltage corresponding to black data to said signal line during a black writing period, and supplies a voltage corresponding to the display data in a previous field or frame temporally stored in said frame memory to said signal line during said display data writing period;

a backlight arranged at the backside of said liquid crystal display panel for illuminating said liquid crystal display panel only during a backlight illuminating period, which is a part of said display data hold period during which said gate signal is kept turned off; and

a temperature detecting unit for detecting a temperature of said liquid crystal display panel; wherein

black data writing start timing for said source driver to start to supply to said signal line a voltage corresponding to said black data during said black writing period and display data writing start timing for said source driver to start to supply to said signal line a voltage corresponding to said display data during said display data writing period are controlled based on the detected temperature of said liquid crystal display panel,

wherein, when the temperature of said liquid crystal display panel is a predetermined temperature or more, said display data writing start timing is controlled to gradually or stepwise delay more relative to said black data writing start timing as the temperature of said liquid crystal display panel is higher.

According to the 11^{th} to 20^{th} present invention, transferring from the bend alignment to the spray alignment is prevented from occurring in a method for causing the backlight to illuminate only during a period in which a liquid crystal display panel responds to display data even at a high temperature.

### BRIEF DESCRIPTION OF THE DRAWINGS

FIG. 1 is a block diagram showing a configuration of the liquid crystal display device according to Embodiments 1 to 6 of the present invention;

FIG. 2 is a diagram showing a timing chart illustrating an operation for the liquid crystal display device according to Embodiment 1 of the present invention to display a video;

FIG. 3 is a diagram showing a timing chart illustrating an operation that can reduce insufficient writing to the liquid crystal display element in the liquid crystal display device according to Embodiment 1 of the present invention;

FIG. 4 is a diagram showing an example of the timing chart illustrating an operation for the liquid crystal display device according to Embodiment 2 of the present invention to display a video;

FIG. 5 is a diagram showing another example of a timing chart illustrating an operation for the liquid crystal display device according to Embodiment 2 of the present invention to display a video;

FIG. 6 is a diagram showing a timing chart illustrating an operation for the liquid crystal display device according to Embodiment 3 of the present invention to display a video;

FIG. 7 is a diagram showing a timing chart illustrating an operation when insufficient writing to the liquid crystal display element occurs in the liquid crystal display device according to Embodiment 1 of the present invention;

FIG. 8 is a diagram showing a timing chart illustrating an operation for the liquid crystal display device according to Embodiment 4 of the present invention to display a video;

FIG. 9 is a diagram showing a timing chart illustrating an operation for reducing insufficient writing to the liquid crystal display element in the liquid crystal display device according to Embodiment 4 of the present invention;

FIG. 10 is a diagram showing an example of a timing chart illustrating an operation for the liquid crystal display device according to Embodiment 5 of the present invention to display a video;

FIG. 11 is a diagram showing a timing chart illustrating an operation for reducing insufficient writing to the liquid crystal display device in the liquid crystal display device according to Embodiment 5 of the present invention;

FIG. 12 is a diagram showing another example of a timing chart illustrating an operation for the liquid crystal display device according to Embodiment 5 of the present invention to display a video;

FIG. 13 is a diagram showing a timing chart illustrating an operation for the liquid crystal display device according to Embodiment 6 of the present invention to display a video;

FIG. 14 is a diagram showing a timing chart illustrating an operation for reducing insufficient writing to the liquid crystal display element in the liquid crystal display device according to Embodiment 6 of the present invention;

FIG. 15 is a block diagram showing a configuration of the liquid crystal display device according to Embodiment 7 of the present invention;

FIG. 16 is a graph showing relationship between a temperature of the liquid crystal display panel and a writing start timing of the display data of the liquid crystal display device according to Embodiment 7 of the present invention;

FIG. 17 is a diagram showing a timing chart illustrating a responding state of each liquid crystal display element at a high temperature of the liquid crystal display device according to Embodiment 7 of the present invention;

FIG. 18 is a block diagram showing a configuration of the liquid crystal display device according to Embodiment 8 of the present invention;

FIG. 19 is a diagram showing a timing chart illustrating a responding state of each liquid crystal display element at a temperature much higher than that of FIG. 17 of the liquid crystal display device according to Embodiment 7 of the present invention;

FIG. 20 is a graph showing relationship between a temperature of the liquid crystal display panel and a timing to start lighting the backlight of the liquid crystal display device according to Embodiment 8 of the present invention;

FIG. 21 is a diagram showing a timing chart illustrating a responding state of each liquid crystal display element at a high temperature illustrated in FIG. 19 of the liquid crystal display device according to Embodiment 8 of the present invention;

FIG. 22 is a block diagram showing a configuration of the liquid crystal display device according to Embodiment 9 of the present invention;

FIG. 23 is a diagram showing a timing chart illustrating a responding state of each liquid crystal display element at a normal temperature and at a high temperature at which a temperature of the liquid crystal display panel is over T₂ of the liquid crystal display device according to Embodiment 9 of the present invention;

FIG. 24 is a block diagram showing a configuration of the liquid crystal display device according to Embodiment 10 of the present invention;

FIG. 25 is a diagram showing a timing chart illustrating an operation for the liquid crystal display device according to Embodiment 10 of the present invention to display a video at a high temperature;

FIG. 26(A) is a diagram showing a bend state of an OCB liquid crystal when white display is provided, (B) a diagram showing a bend state of an OCB liquid crystal when black display is provided, and (C) a diagram showing a spray state of an OCB liquid crystal;

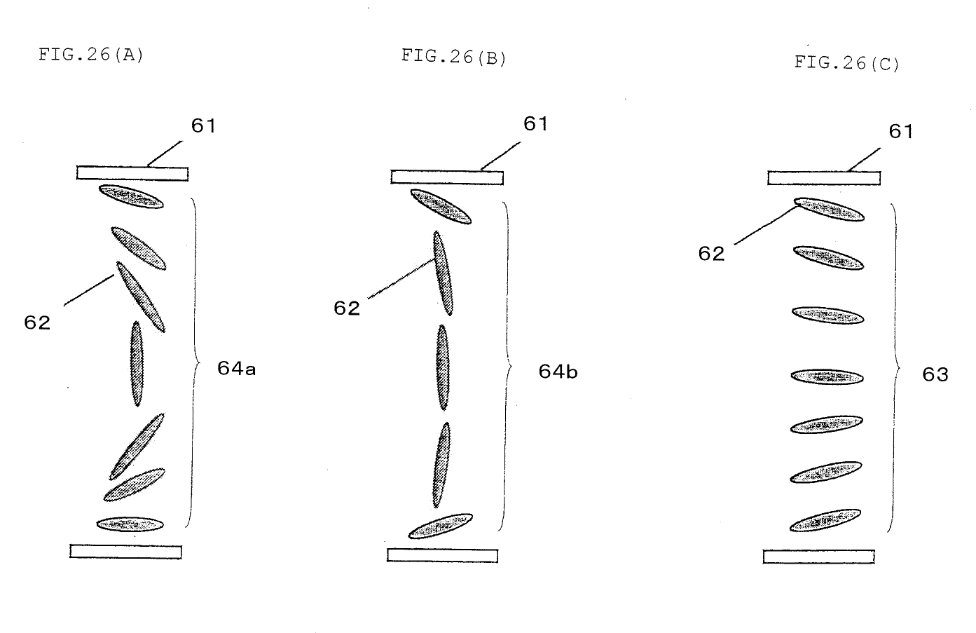

FIG. 27 is a configuration diagram of the liquid crystal display device using a conventional OCB mode liquid crystal display element;

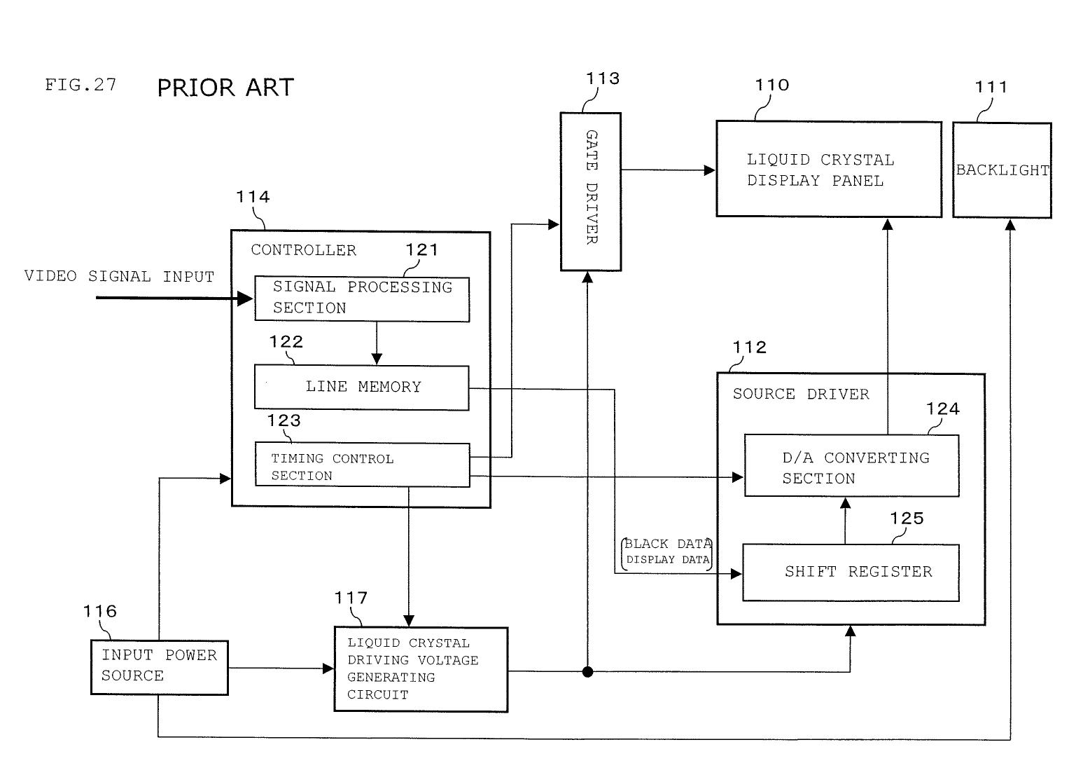

FIG. 28 is a diagram showing a timing chart of a drive in which transferring from the bend alignment to the spray alignment is prevented by double-speed conversion in a conventional liquid crystal display device;

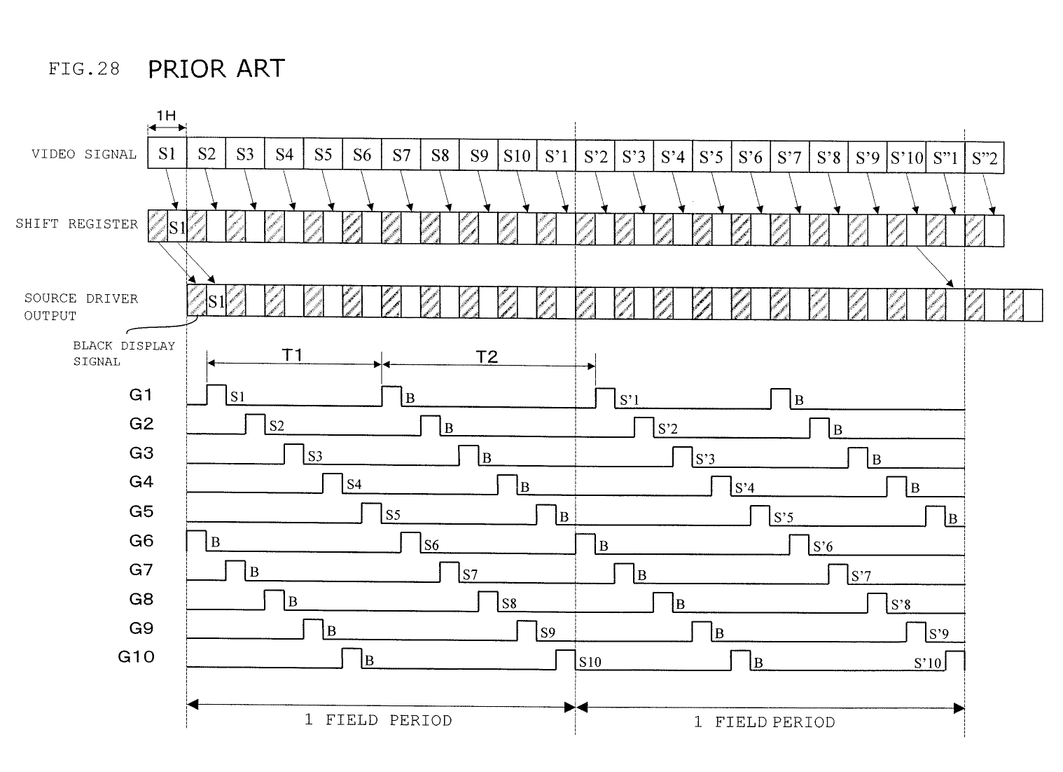

FIG. 29 is a configuration diagram of the liquid crystal display device in a conventional method for causing a backlight to illuminate only while the liquid crystal display device responds to the display data;

FIG. 30 is a diagram showing a timing chart illustrating an operation of the liquid crystal display device in a conventional method for causing a backlight to illuminate only while the liquid crystal display device responds to the display data;

FIG. 31 is a diagram showing a timing chart illustrating an operation in a case where insufficient writing to the liquid crystal display element occurs in the liquid crystal display device in a conventional method for causing a backlight to illuminate only while the liquid crystal display element responds to the display data;

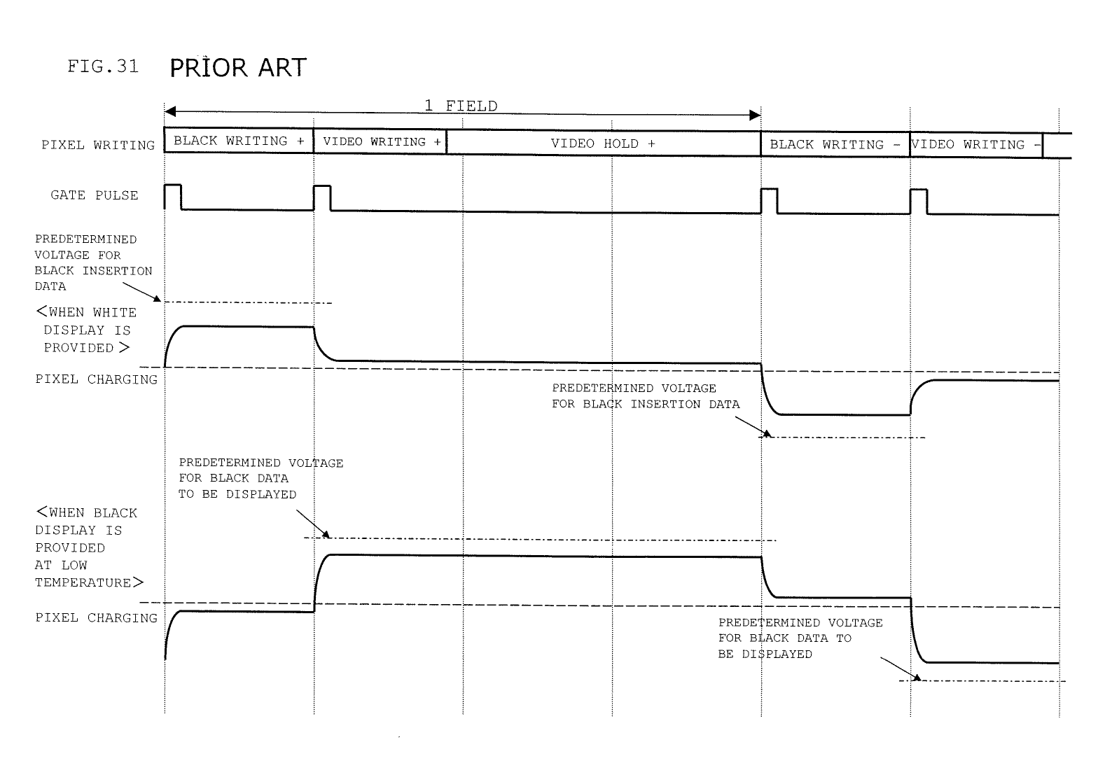

FIG. 32 is a graph showing relationship between a surface temperature of the liquid crystal display panel and an appropriate black insertion ratio in the liquid crystal display device; and

FIG. 33 is a diagram showing a timing chart illustrating a responding state of each of liquid crystal display elements in the liquid crystal display device in a conventional method for causing a backlight to illuminate only while the liquid crystal display element responds to the display data.

[Description of Symbols]

10 liquid crystal display panel
11 backlight
12 source driver
13 gate driver
14, 30, 32, 33, 34 controller
15 frame memory
16 input power source
17, 37 liquid crystal driving voltage generating circuit
21 signal processing section
22, 26, 28, 31, 35 timing control section
23 D/A converting section
24 shift register
41 timing available to start display data writing
42 timing to decide starting of display data writing
43 timing to complete liquid crystal response
44 timing to decide starting of lighting a backlight
61 glass base material
62 liquid crystal molecule
63 spray state
64a, 64b bend state
110 liquid crystal display panel
111, 130 backlight
112 source driver
113 gate driver
114 controller
115 frame memory
116 input power source
117 liquid crystal driving voltage generating circuit
121 signal processing section
122 line memory
123, 133 timing control section
124 D/A converting section
125 shift register

### DETAILED DESCRIPTION OF THE PREFERRED EMBODIMENTS

According to the present invention, a liquid crystal display device and a method for driving the liquid crystal display device that can reduce insufficient writing to the liquid crystal display element when a voltage corresponding to black data to be inserted for preventing transferring from the bend alignment to the spray alignment is supplied in a display method for causing a backlight to illuminate only while the liquid crystal display element responds to display data can be provided.

According to another present invention, a liquid crystal display device and a method for driving the liquid crystal display device that can prevent occurrence transferring from the bend alignment to the spray alignment even at a high temperature in a method for causing a backlight to illuminate only while the liquid crystal display element responds to display data can be provided.

Description will be given below of Embodiments of the present invention with reference to the drawings below.

### Embodiment 1

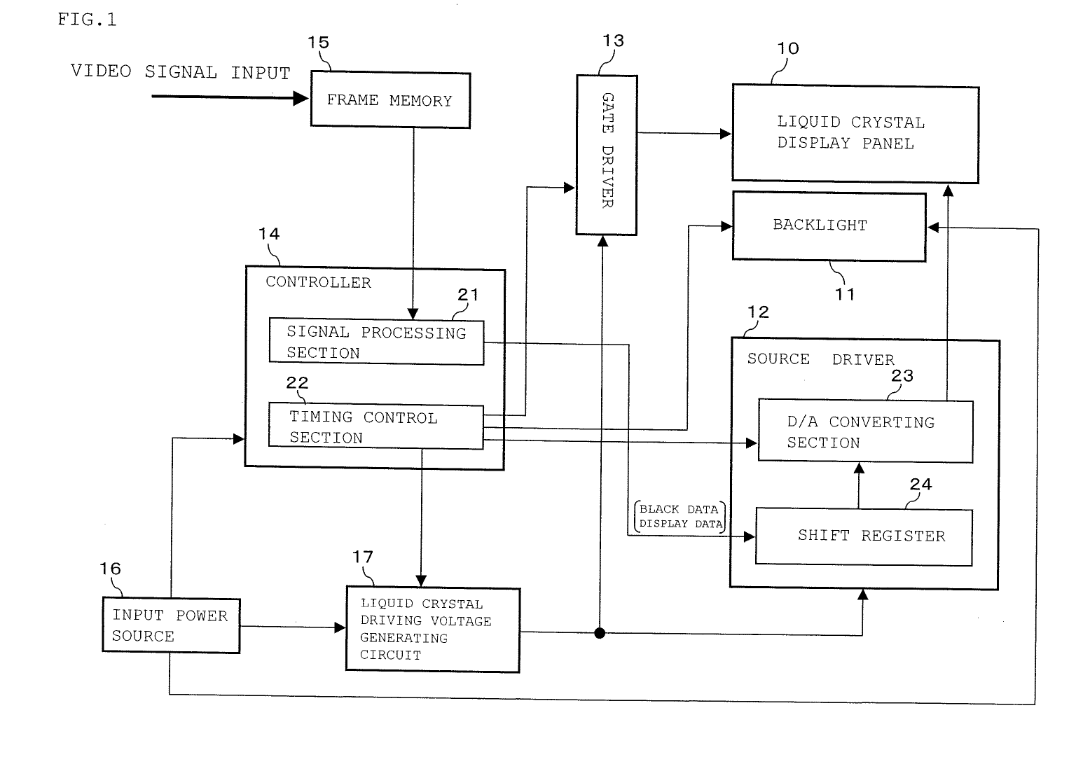

FIG. 1 is a block diagram showing a configuration of a liquid crystal display device according to Embodiment 1 of the present invention.

The liquid crystal display device according to Embodiment 1 includes a liquid crystal display panel 10, a backlight 11, a source driver 12, a gate driver 13, a controller 14, a frame memory 15, an input power source 16, and a liquid crystal driving voltage generating circuit 17.

The liquid crystal display panel 10 comprises signal lines and scan lines arranged in a matrix and an OCB mode liquid crystal display element provided on an intersection point between them.

The backlight 11 is arranged at the backside of the liquid crystal display panel 10 for illuminating the liquid crystal display panel 10 with a plurality of short afterglow type cold cathode tubes.

The frame memory 15 is a storage section, which temporally stores data of an immediately previous field of inputted video signal data.

The input power source 16 supplies power to the backlight 11, the controller 14, and the liquid crystal driving voltage generating circuit 17. The liquid crystal driving voltage generating circuit 17 adjusts voltages to be supplied to the source driver 12 and the gate driver 13 when the display data is displayed on the liquid crystal display panel 10.

The gate driver 13 supplies gate signals to the scan lines of the liquid crystal display panel 10. The source driver 12 supplies a voltage corresponding to a display signal to each signal line of the liquid crystal display panel 10.

The controller 14 comprises a signal processing section 21 and a timing control section 22. The source driver 12 comprises a D/A converting section 23 and a shift resister 24. The timing control section 22 executes ON/OFF controlling on the backlight 11 and also controls an output timing of a gate signal supplied by the gate driver 13.

Description will be given below of a display operation in the liquid crystal display device according to Embodiment 1 with reference to FIG. 1.

The video signal, which is RGB data, is temporally stored in the frame memory 15.

The signal processing section 21 in the controller 14 reads immediately previous field data stored in the frame memory 15 and executes gray scale correction or gamma correction on the video signal. Then, the signal processing section 21 transfers display data, which has been subjected to the correction, to the shift register 24 of the source driver 12 by pixels in one line according to a start pulse from the timing control section 22.

The signal processing section 21 also transfers black data for preventing transferring from the bend alignment to the spray alignment to the shift register 24 by pixels in one line according to a start pulse from the timing control section 22.

Then, the timing control section 22 of the controller 14 outputs a load pulse to the D/A converting section 23 of the source driver 12. The D/A converting section 23 obtains data stored in the shift register 24 for pixels in one line at a time when a load pulse is input, executes the D/A conversion on the data, and outputs a voltage corresponding to each piece of display data to the signal lines of the liquid crystal display panel 10.

In response, the timing control section 22 controls an output timing of a gate signal to be output from the gate driver 13 to each scan line, lights the backlight 11 when each liquid crystal display element of the liquid crystal display panel 10 responds to display data, and then displays the display data on the liquid crystal display panel 10.

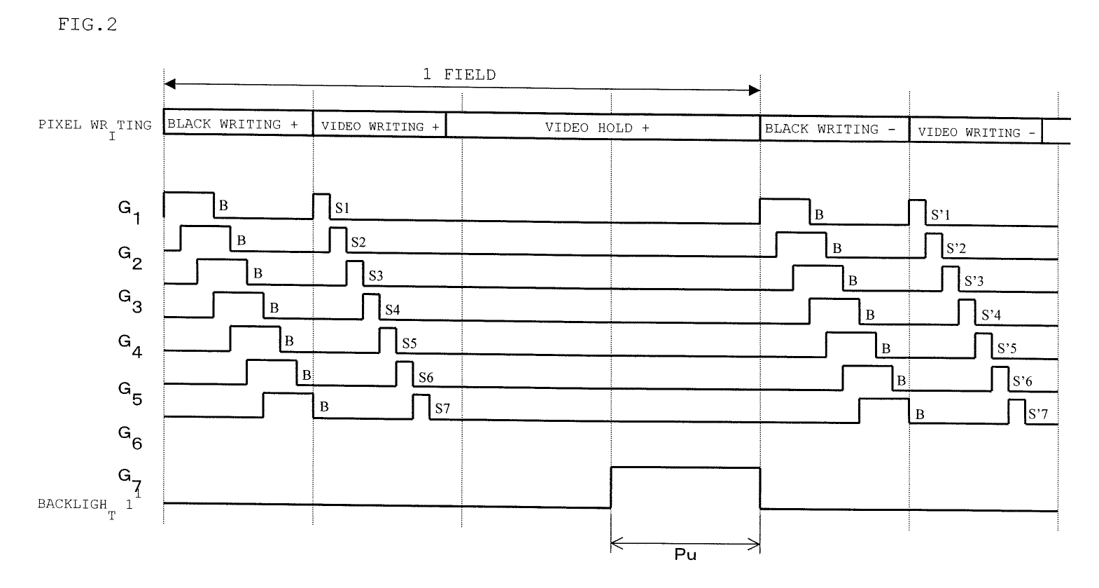

Description will be given below of details of an operation of writing to each liquid crystal display element in the liquid crystal display device according to Embodiment 1 with reference to FIGS. 1 and 2.

FIG. 2 shows a timing chart illustrating an operation for the liquid crystal display device according to Embodiment 1 to display a video.

A period of a field (or a frame) is divided into a black writing period, a video writing period and a video HOLD period for writing to each liquid crystal display element, and black data for preventing transferring from the bend alignment to the spray alignment is written during a black writing period and display data is written in a video writing period.

The reference characters G1 to G7 in FIG. 2 show gate signals output from the gate driver 13 to respective gate lines. The reference characters shown to the right of respective gate signals denote display data or black insertion data (B) to be written in an image cell when the corresponding gate signal becomes high. Each of the signs (+, −) shown during each pixel writing period of FIG. 2 shows a polarity of a voltage to be supplied when data is written in the liquid crystal display element. In this case, a polarity of a writing voltage to the liquid crystal display element is reversed at each field.

First, a gate pulse is sequentially generated to the corresponding scan line during a black writing period, and black data (B) for preventing transferring from the bend alignment to the spray alignment is written. Then, a gate pulse is sequentially generated to the corresponding scan line during the video writing period and display data (S1 to S7) in an immediately previous field stored in the frame memory 15 is written. The timing control section 22 controls a width of a gate pulse to be generated when black data is written in a black writing period so as to be a pulse width three times the width of the gate pulse to be generated when the display data is written in the video writing period.

Then, the timing control section 22 controls ON/OFF of the backlight 11 so that a gate is turned off during the video HOLD period and the backlight 11 lights during a period after all the liquid crystal display elements responds until the next black data is written. In the case of Embodiment 1 shown in FIG. 2, the backlight 11 is controlled to light during the last 25% of a field period (Pu period).

Such controlling can realize an impulse type video display with quite good motion picture quality by using the OCB mode liquid crystal display element. As the backlight 11 is turned off while the liquid crystal display element responds to black data written in the black writing period, the contrast can be improved and the electronic power consumption can be reduced.

In the liquid crystal display device according to Embodiment 1, as a width of a gate pulse to be generated in writing black data for preventing transferring from the bend alignment to the spray alignment is widened and a period in which a voltage is supplied to the corresponding liquid crystal display element is increased, in sufficient writing to the liquid crystal display element does not occur.

Description will be given below of a principle of reducing insufficient writing to the liquid crystal display element in the liquid crystal display device according to Embodiment 1.

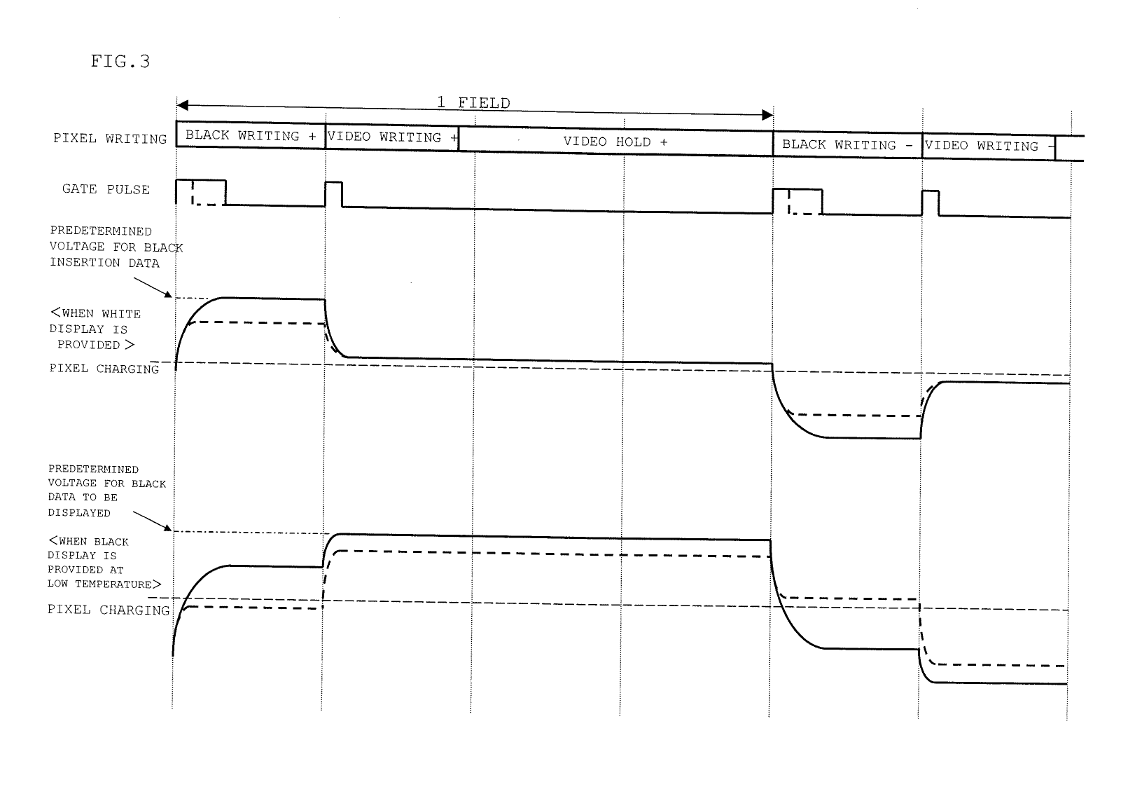

FIG. 3 shows a timing chart illustrating an operation that can reduce insufficient writing to the liquid crystal display element in the liquid crystal display device according to Embodiment 1. The figure shows a state of a voltage charged to each liquid crystal display element in the case where white display is provided and where black display is provided at the low temperature.

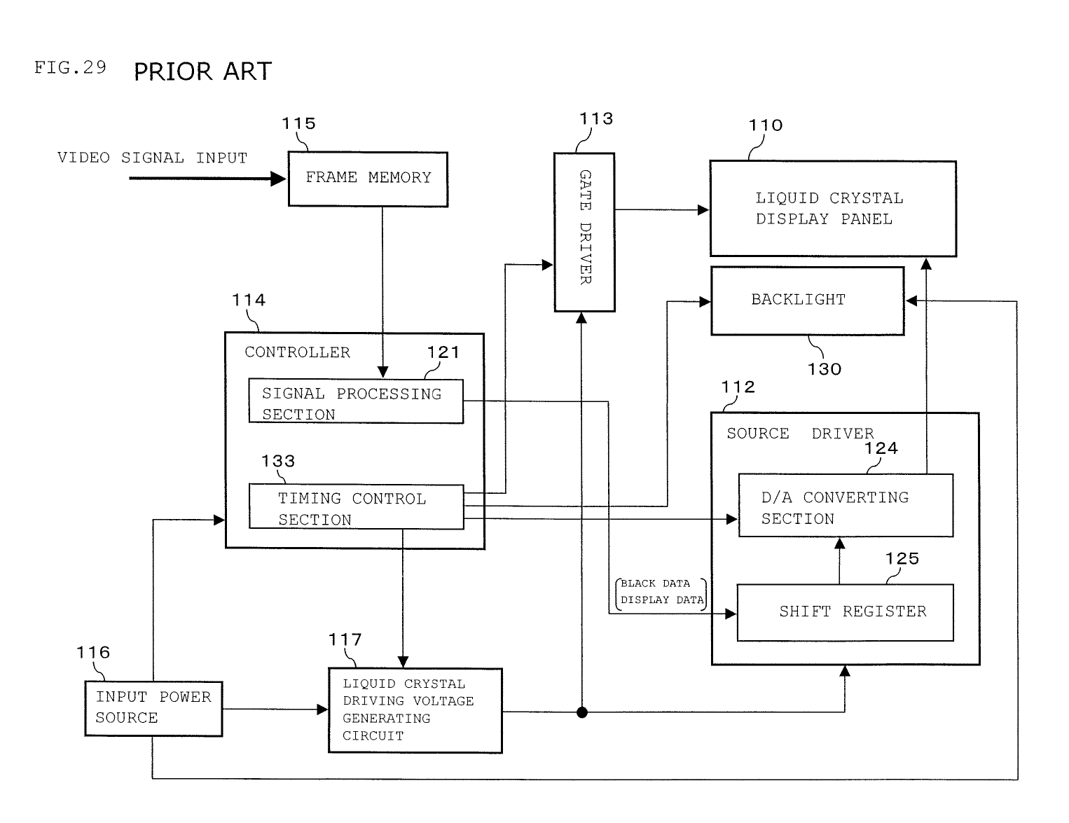

Parts shown by dotted lines denote states of the gate pulse and a voltage charged to the liquid crystal display element in a conventional display method of the liquid crystal display device shown in FIG. 29. Parts shown by solid lines show states of the gate pulse and a voltage to be charged to the liquid crystal display element in the liquid crystal display device in Embodiment 1.

First, description will be given of a case where white display that is hard to be written in the liquid crystal display element is provided.

A “predetermined voltage for black insertion data” shown in FIG. 3 means a voltage to be written in the liquid crystal display element for the black data to be inserted for preventing transferring from the bend alignment to the spray alignment. When the liquid crystal display element is charged to the predetermined voltage value for the black data, transferring from the bend alignment to the spray alignment can be prevented.

The “predetermined voltage for black insertion data” is an example of a predetermined voltage value required to avoid transferring from the bend alignment to the spray alignment for the liquid crystal display element of the present invention.

In the conventional display method of the liquid crystal display device, as shown by a dotted line of “when white display is provided” in FIG. 3, the liquid crystal display element is not charged to the predetermined voltage value while the gate pulse is generated during the black writing period so that insufficient writing occurs.

In contrast, in the case of the liquid crystal display device according to Embodiment 1, as denoted by solid lines of “when white display is provided” in FIG. 3, a width of the gate pulse during the black writing period is three times the gate pulse width in writing a display data, the liquid crystal display element is charged to the “predetermined voltage for black insertion data” while the gate pulse is generated. As a result, insufficient writing does not occur. That can certainly prevent a phenomenon transferring from the bend alignment to the spray alignment.

Description will be given below of a case where black display is provided at low temperature at which a phenomenon transferring from the bend alignment to the spray alignment is hard to occur.

As the temperature decreases, a phenomenon transferring from the bend alignment to the spray alignment seldom occurs, the “predetermined voltage for black insertion data” shown in FIG. 3 becomes a lower voltage value as the temperature decreases. Thus, from the viewpoint preventing transferring from the bend alignment to the spray alignment, as the temperature decreases, a voltage value which needs to be charged to the liquid crystal display element during the black writing period may be lower.

The “predetermined voltage for display black data” shown in FIG. 2 means a voltage which should be written in the liquid crystal display element for the black data to be displayed. If the liquid crystal display element is charged to the predetermined voltage value for the black data to be displayed, black is normally displayed.

In the conventional display method of the liquid crystal display device, as shown by broken lines of “when black display is provided at a low temperature” of FIG. 3, writing to the liquid crystal display element becomes insufficient so that an electric potential does not sufficiently rises when black data for preventing transferring from the bend alignment to the spray alignment is written during the black writing period. Thus, the liquid crystal display element is not charged to a predetermined voltage value for the black data to be displayed while the gate pulse is generated when black data of display data is written during the video writing period following to the black writing period. As a result, black is displayed in a half tone, lowering the contrast.

In contrast, in the case of the liquid crystal display device according to Embodiment 1, a width of a gate pulse during the black writing period is a width three times the gate pulse width in writing display data, the liquid crystal display element is charged to a voltage higher than that in a conventional display method of the liquid crystal display device when black data for preventing transferring from the bend alignment to the spray alignment is written during the black writing period as shown by solid lines of the “when black display is provided at a low temperature” of FIG. 3. Thus, as the liquid crystal display element is charged to the “predetermined voltage for black data to be displayed” value while the gate pulse is generated when black data to be displayed is written during the video writing period following to the black writing period, black is normally displayed so that display with the contrast being not lowered can be achieved even at a low temperature.

When black display is provided at a low temperature, the liquid crystal display element is not charged to the “predetermined voltage for black insertion data” value at a normal temperature for black data for preventing transferring from the bend alignment to the spray alignment during the black writing period but transferring from the bend alignment to the spray alignment seldom occurs at a low temperature. Thus, transferring from the bend alignment to the spray alignment is not generated.

As shown in FIG. 2, in the liquid crystal display device according to Embodiment 1, although a period during which the gate signal is turned on occurs to a plurality of scan lines as a width of a gate pulse is increased during the black writing period, data to be written on the liquid crystal element on each scan line is also black data and the backlight 11 is turned off while black data for preventing transferring from the bend alignment to the spray alignment is written in the liquid crystal display element so that no black data is displayed. Thus, there is no problem even if there is a period during which a gate signal is turned on at the same time.

In the liquid crystal display device according to Embodiment 1, although a width of the gate pulse during the black writing period is three times the gate pulse width for display data during the video writing period, in order to prevent transferring from the bend alignment to the spray alignment, the period only needs to be a period in which the voltage value to be charged to the liquid crystal display element reaches the “predetermined voltage for black insertion data” value at the time “when white display is provided” of FIG. 3. In order to prevent the contrast from being lowered at a low temperature, the period only needs to be a period in which a voltage value to be charged to the liquid crystal display element for the black data to be displayed at the time “when black display is provided at a low temperature” of FIG. 3 reaches the “predetermined voltage for black data to be displayed” value or more.

Thus, widths of a gate pulse during the black writing period may be twice, fourfold or fivefold, . . . of the gate pulse width for display data to match characteristics of the liquid crystal display device. The width of the gate pulse during the black writing period is not necessarily be an integer number times the gate pulse width for the display data and may be 1.5 times, 2.5 times or the like.

### Embodiment 2

Description will be given below of a display operation of the liquid crystal display device according to Embodiment 2 of the present invention.

The liquid crystal display device according to Embodiment 2 has the same configuration as that of the liquid crystal display device according to Embodiment 1 and as shown in FIG. 1. The controlling on the gate driver 13 of the timing control section 22 is different from that of the liquid crystal display device according to Embodiment 1.

In FIG. 2, the timing when a gate pulse is generated during the black writing period only needs to be a timing when a period for keeping a voltage for black data for preventing transferring from the bend alignment to the spray alignment to be charged is the minimum for preventing transferring from the bend alignment to the spray alignment or more for each liquid crystal display element (a period during which transferring from the bend alignment to the spray alignment does not occur if only a voltage corresponding to black data is charged for a period longer than that).

Therefore, it does not need to be a timing to be synchronized with a timing of a gate pulse corresponding to display data during the video writing period as shown in FIG. 2.

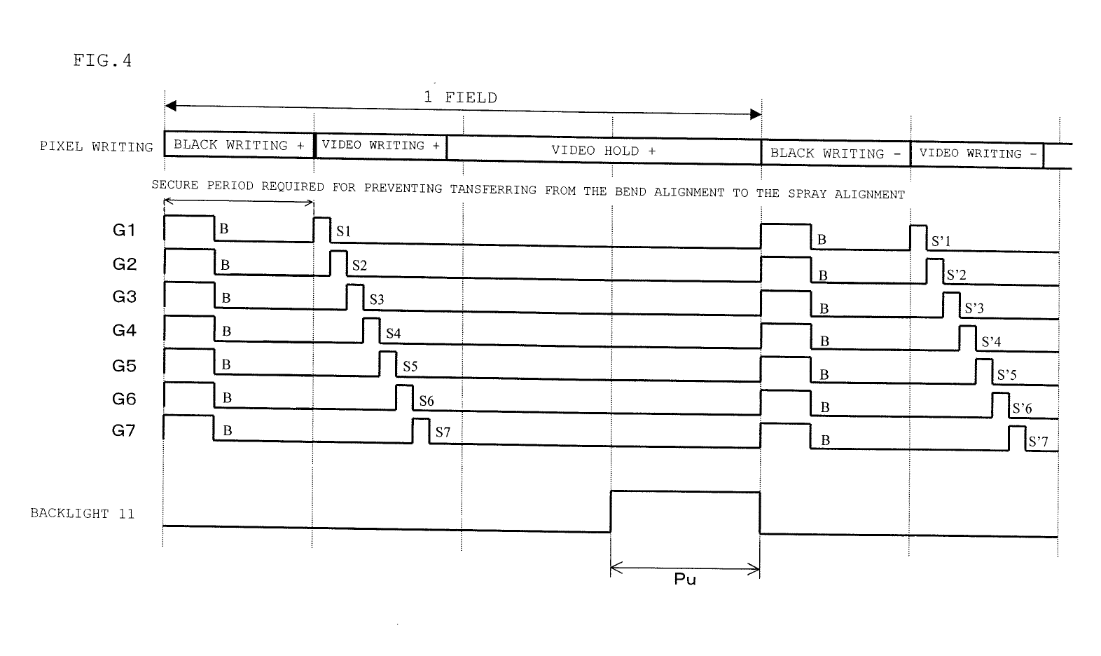

FIG. 4 shows an example of the timing chart illustrating an operation for displaying a video in the liquid crystal display device according to Embodiment 2.

In the case of FIG. 4, the timing control section 22 shown in FIG. 1 generates a gate pulse with the same width for all the gate lines at a time for all the gate pulses during the black writing period. The width of the gate pulse here may be set as a width matched to the characteristics of the liquid crystal display device as described in Embodiment 1.

The timing control section 22 generates a gate pulse during the black writing period when the period for the liquid crystal display element with the shortest period during which a voltage for black data for preventing transferring from the bend alignment to the spray alignment being kept charged is the minimum period during which transferring from the bend alignment to the spray alignment does not occur (a period during which transferring from the bend alignment to the spray alignment does not occur if only a voltage for black data is charged during a period more than that) or more.

The minimum period during which transferring from the bend alignment to the spray alignment does not occur is an example of a predetermined period during which transferring from the bend alignment to the spray alignment does not occur of the present invention.

In the case of FIG. 4, as the gate pulse G1 on the scan line shown at the top is turned on first among the gate pulses G1 to G7 of the corresponding scan line to be generated when display data is written, a period during which a voltage corresponding to black data for preventing transferring from the bend alignment to the spray alignment is charged to the liquid crystal display element on the scan line corresponding to the gate pulse G1 only needs to be the minimum period during which transferring from the bend alignment to the spray alignment does not occur or more.

Therefore, in the case of FIG. 4, although the gate pulse for writing black data for preventing transferring from the bend alignment to the spray alignment is turned on at the beginning of the black writing period, the gate pulse may be turned on at another timing during the black period, if only the timing is such that a period during which a voltage corresponding to black data is charged to the liquid crystal display element on the top of the scan line is not less than more than the minimum period during which transferring from the bend alignment to the spray alignment does not occur or more.

In the liquid crystal display device according to Embodiment 2 that generates a gate pulse at such a timing as shown in FIG. 4, the timing for the gate pulse to be generated in the black writing period can be the same for all the scan lines so that an output timing of a gate pulse cab be easily controlled.

If all the gate pulses are turned on at the same time, occurrence of a rush current may adversely affect an operation of the liquid crystal display device.

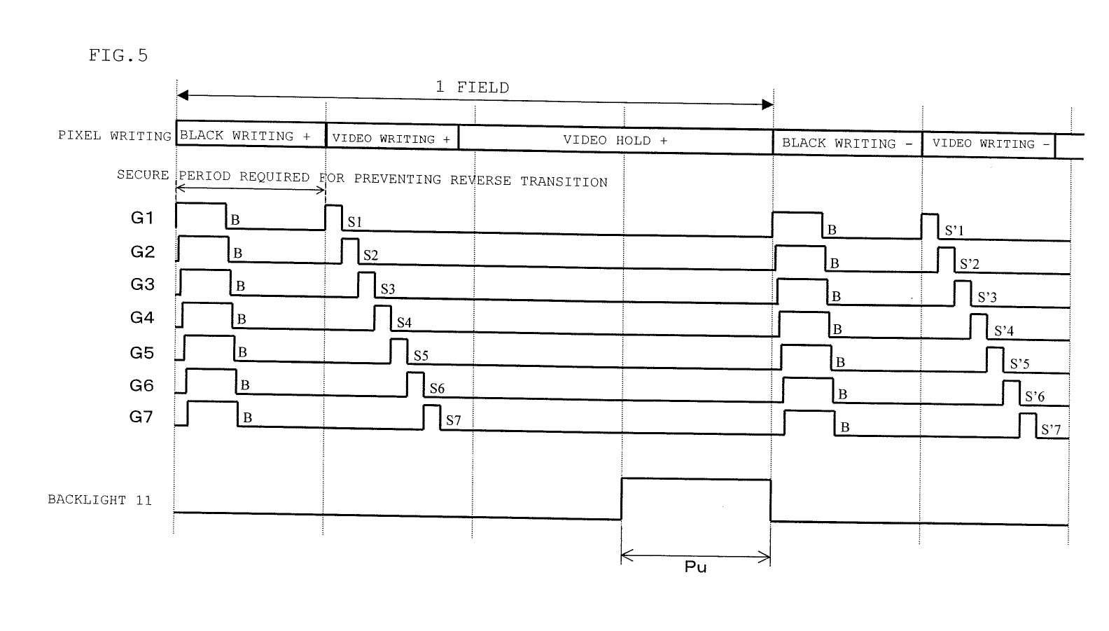

FIG. 5 shows another example of a timing chart illustrating an operation for the liquid crystal display device according to Embodiment 2 to display a video.

In the case of FIG. 5, the timing control section 22 controls a timing for the gate pulse to the corresponding scan line to be almost the same but a little bit different so that an incoming current is not generated. By controlling in this manner, occurrence of the incoming current can be prevented.

In FIG. 5, although timings for the gate pulses on the respective corresponding scan lines to be different little, the scan lines may be divided in a plurality of groups, for example, so that the timings for the gate pulses on the scan lines in each group are the same and the timing for the gate pulses is different little among each group.

The minimum period during which transferring from the bend alignment to the spray alignment does not occur depends on characteristics of the liquid crystal or a temperature at which the liquid crystal is used. Thus, the timing for the gate pulse on the corresponding scan line set in FIG. 4 or FIG. 5 may be set according to characteristics of the liquid crystal display device used or an environment in which the liquid crystal display device is used.

### Embodiment 3

Description will be given below of a display operation of the liquid crystal display device according of Embodiment 3 of the present invention.

The liquid crystal display device according to Embodiment 3 has the same configuration as that of the liquid crystal display device according to Embodiment 1 as shown in FIG. 1. The controlling on the gate driver 13 of the timing control section 22 is different from that of the liquid crystal display device according to Embodiment 1.

In the embodiments 1 and 2, a voltage to be supplied to the liquid crystal display element is reversed for each field, and thus, the gate pulse width when black data for preventing transferring from the bend alignment to the spray alignment is written is increased for all the fields. If data is continuously written at a voltage with the same polarity, less insufficient writing occurs than in the case where the data is written with the polarity reversed. For the liquid crystal display device for reversing a voltage to be supplied to the liquid crystal display element for a plurality of fields, the gate pulse width may be widen only when the polarity is reversed.

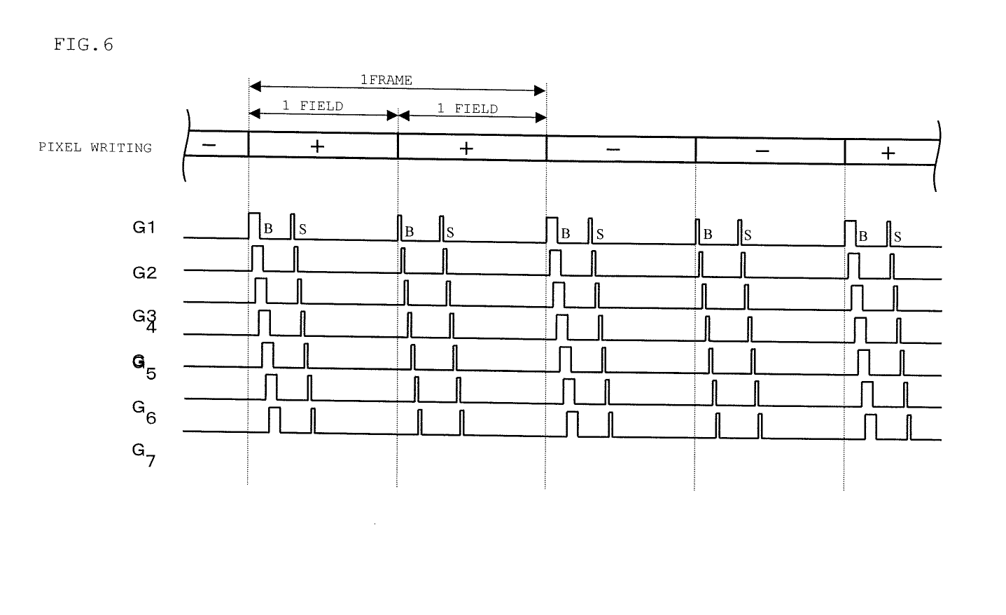

FIG. 6 shows an example of a timing chart illustrating an operation for the liquid crystal display device according to Embodiment 3 to display a video.

As shown in FIG. 6, the liquid crystal display device according to Embodiment 3 is a liquid crystal display device in which a frame comprises two fields and a polarity of a voltage to be supplied to the liquid crystal display element is reversed for each frame.

In such a case, as a voltage is supplied to the liquid crystal display element with the same polarity in the two fields in a frame, a gate pulse width when black data is written during the black writing period is a normal pulse width in the second field in a frame. Then, when the frame changes, the polarity of a voltage to be supplied to the liquid crystal display element is reversed and insufficient writing becomes more likely to occur. Thus, in the first field in a frame, the gate pulse width when the black data is written is controlled to be wide.

### Embodiment 4

Description will be given below of a display operation of the liquid crystal display device according to Embodiment 4 of the present invention.

The liquid crystal display device according to Embodiment 4 has the same configuration as that of the liquid crystal display device according to Embodiment 1 as shown in FIG. 1. The controlling on the gate driver 13 of the timing control section 22 and a method for writing the display data to the liquid crystal display element are different from those of the liquid crystal display device according to embodiments 1 to 3.

As such a driving method as those in the first to the third embodiments is used in the liquid crystal display device in a method for causing a backlight to illuminate only while the display data is responded, black data for preventing transferring from the bend alignment to the spray alignment is correctly written so that the phenomenon transferring from the bend alignment to the spray alignment can be reduced. As black data is correctly written, the brightness displayed may decrease due to the resulting insufficient writing to the liquid crystal display element when a color with high brightness such as white is displayed at low temperature.

First, description will be given below of a problem in that the brightness displayed at the low temperature decreases.

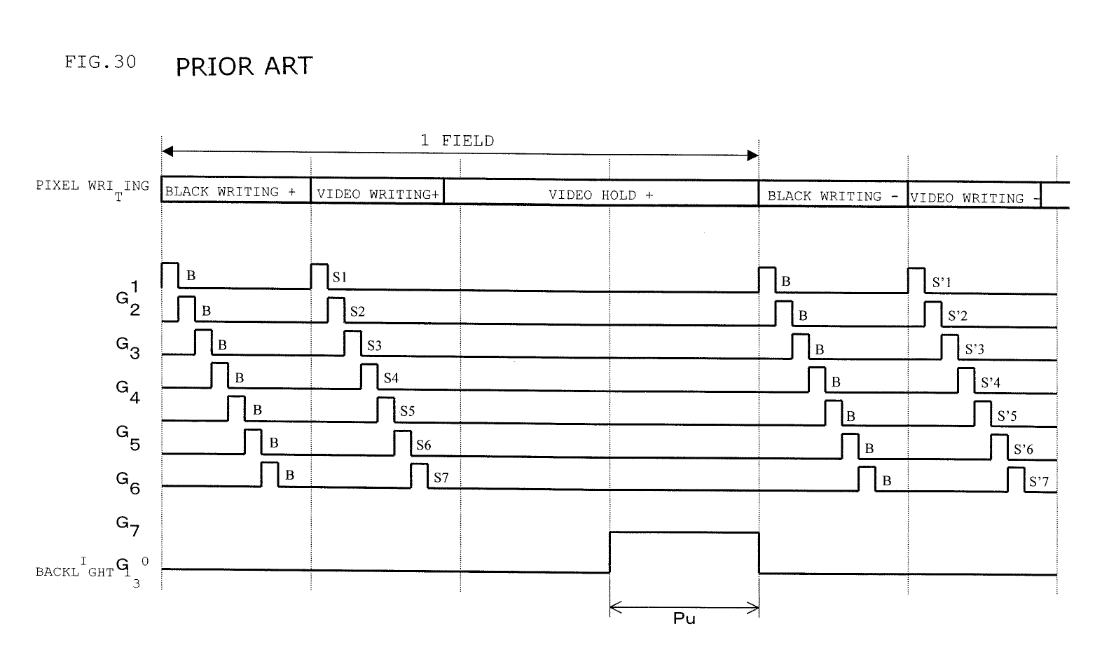

The liquid crystal display device according to Embodiments 1 to 3 widens the gate pulse width during the black writing period to correctly write black data for preventing transferring from the bend alignment to the spray alignment to the liquid crystal display element. Accordingly, as the liquid crystal display elements can completely have a black electric potential so that black with the minimum brightness which easily causes insufficient writing at a low temperature in the conventional driving method as shown in FIG. 30 can be displayed.

As the liquid crystal display elements completely have a black electric potential during the black writing period, an electric potential difference becomes wide against the black electric potential when the high brightness such as white is display, and thus, insufficient writing may occur. Particularly at the low temperature, a responding speed of the liquid crystal display element slows down, an insufficient writing phenomenon occurs more easily.

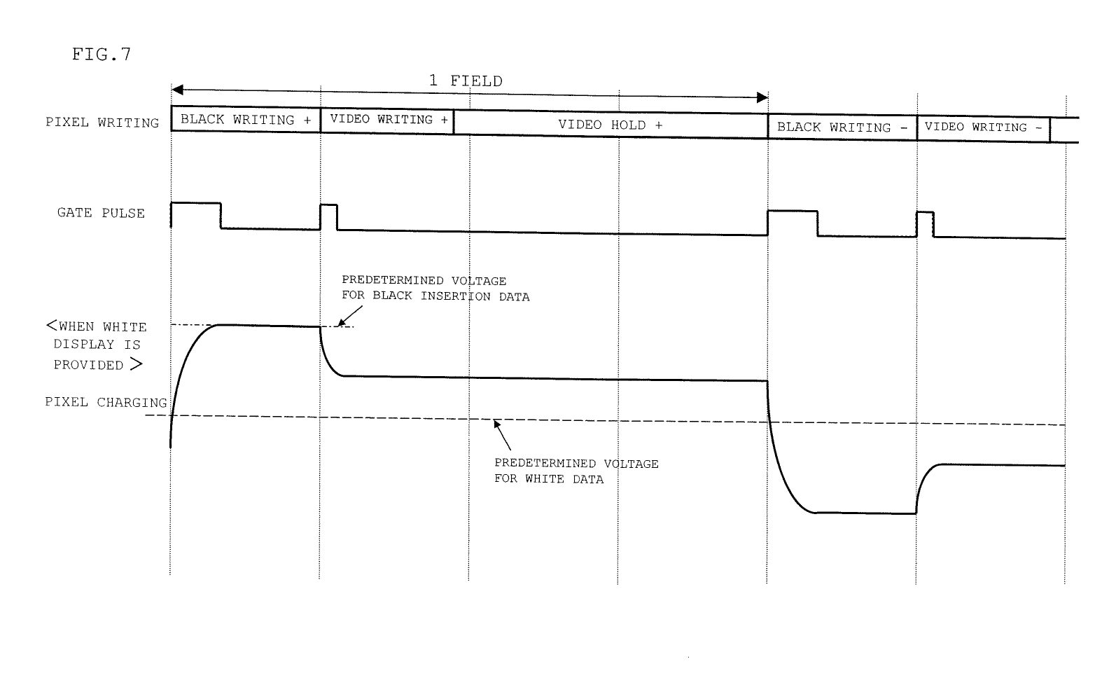

FIG. 7 shows a timing chart illustrating an operation when insufficient writing to the liquid crystal display element occurs in the method for driving the liquid crystal display device according to Embodiment 1 shown in FIG. 2. The figure shows a state of a voltage to be charged to the liquid crystal display element when white display of the maximum brightness is provided.

As a voltage to the liquid crystal display element is supplied only while a gate pulse is generated, insufficient writing occurs if the liquid crystal display element is not charged to a necessary voltage value during the period a gate pulse is generated.

The “predetermined voltage for black insertion data” shown in FIG. 7 means a voltage to be written in the liquid crystal display element for black data to be inserted for preventing transferring from the bend alignment to the spray alignment. If only the liquid crystal display element is charged to the predetermined voltage value for the black data, transferring from the bend alignment to the spray alignment can be prevented. In such a case, as a width of the gate pulse when black data is written is wide, a voltage to be charged to the liquid crystal display element reaches the “predetermined voltage for black insertion data”.

The “predetermined voltage for white data” shown in FIG. 7 means a voltage to be written in the liquid crystal display element for white display data. If the liquid crystal display element is charged to the “predetermined voltage for white data” value in a period during which a gate pulse during the video writing period is generated, white display is provided with normal brightness.

In the case of display data with low brightness such as black, as an electric potential difference against black electric potential charged during the black writing period is small, the liquid crystal display element can be charged to a voltage value required for the display data within a period during which a gate pulse is generated in the video writing period so that the video can be displayed with normal brightness. In the case of display data with high brightness such as white, the liquid crystal display element cannot be charged to the voltage value required for the display data with in a period during which a gate pulse is generated in the video writing period as shown in FIG. 7 due to a wide electric potential difference against the black electric potential. Thus, in such a case, insufficient writing to the liquid crystal display element occurs and a video with low brightness is displayed.

That phenomenon easily occurs as the temperature decreases, lowering brightness displayed on the screen.

The method for driving the liquid crystal display device according to Embodiment 4 reduces a phenomenon of lowering brightness displayed at such a low temperature.

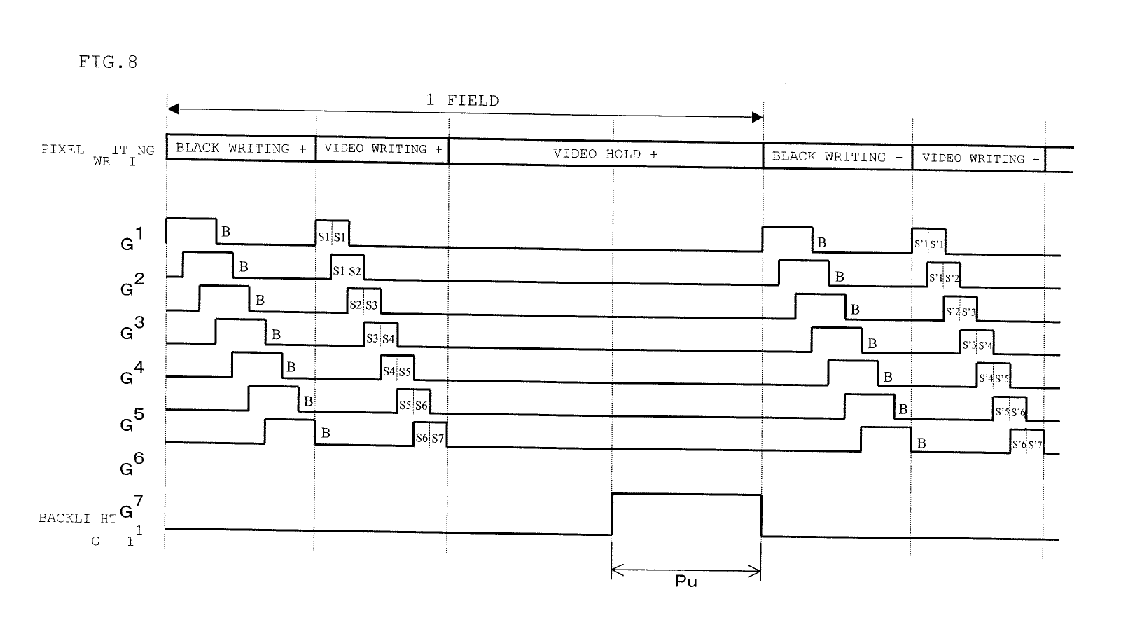

Description will be given below of details of a writing operation to each liquid crystal display element in the liquid crystal display device according to Embodiment 4 with reference to FIG. 1 and FIG. 8.

FIG. 8 shows a timing chart illustrating an operation for the liquid crystal display device according to Embodiment 4 to display a video.

The reference characters G1 to G7 of FIG. 8 show gate signals output from the gate driver 13 to respective gate lines. The reference characters shown in pulse parts of respective gate signals denote the display data or black insertion data (B) which is written in an image cell when the corresponding gate signal becomes high. Each of the signs (+, −) shown during each pixel writing period of FIG. 8 shows a polarity of a voltage to be supplied when data is written in the liquid crystal display element. In this case, a polarity of a writing voltage to the liquid crystal display element is reversed for each field.

First, a gate pulse is sequentially generated in the corresponding scan line during the black writing period and black data for preventing transferring from the bend alignment to the spray alignment is written. Here, a width of the gate pulse to be generated when black data is written during the black writing period is controlled by the timing control section 22 so that the width becomes wide enough to certainly charge the liquid crystal display element to a black electric potential as in the driving method in Embodiments 1 to 3.

Thereafter, gate pulses are sequentially generated in the corresponding scan lines and display data in an immediately previous field stored in the frame memory 15 is written during the video writing period. The timing control section 22 controls a width of a gate pulse to be generated when display data is written during the video writing period so that the width becomes wide enough to reach from black electric potential with which the liquid crystal display element is charged during the black writing period to the electric potential required for the display data.

Here, a width of a gate pulse to be generated during the video writing period is set as twice the length of a period required for writing display data for a line. Here, the length of the video writing period is the same as the total time for sequentially executing ON/OFF of each of the gate signals G1 to G7 for a line (the video writing period shown in FIG. 30), and therefore a timing for two gate signals to be turned on at the same time is present as shown in FIG. 8. In the example of FIG. 8, display data in an immediately before line is written in the first half of the gate pulse and display data for the line is written in the latter half.

A period required for writing display data for a line is a line writing period of the present invention.

The timing control section 22 controls ON/OFF of the backlight 11 so that a gate is turned off during the video HOLD period and the backlight 11 lights during a period after all the liquid crystal display elements respond and before the next black data is written. In the case of Embodiment 4 shown in FIG. 8, it is controlled so that the backlight 11 lights in the last 25% period of a field period (Pu period).

By controlling in such a manner, impulse type video display can be implemented with quite good motion picture quality by using the OCB mode liquid crystal display element. As the backlight 11 is turned off while the liquid crystal display element responds to black data written during the black writing period, the contrast can be improved and the power consumption can be reduced.

In the liquid crystal device according to Embodiment 4, as a width of a gate pulse to be generated when black data for preventing transferring from the bend alignment to the spray alignment is written is widened and a width of a gate pulse to be generated when display data is written is widened so that a period during which a voltage is supplied to each liquid crystal display element when display data is written is extended, no insufficient writing to the liquid crystal display element occurs also for display data with high brightness.

Description will be given below of a principle for reducing insufficient writing to the liquid crystal display element for display data in the liquid crystal display device according to Embodiment 4.

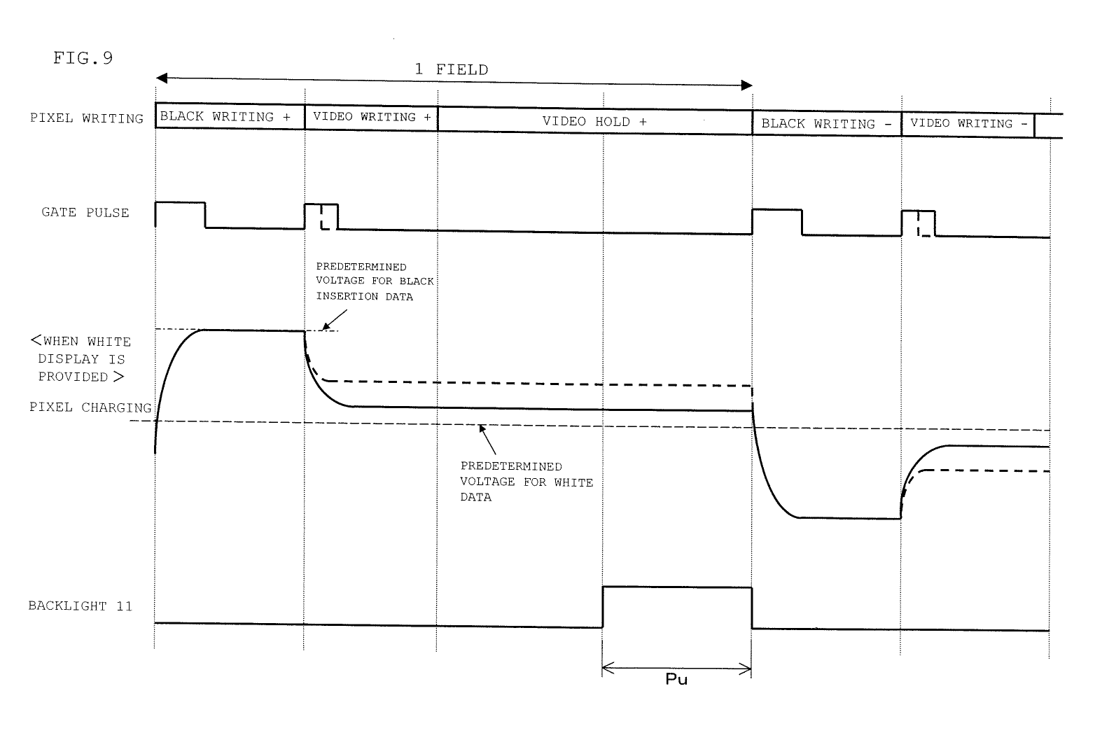

FIG. 9 shows a timing chart illustrating an operation for reducing insufficient writing to the liquid crystal display element for display data in the liquid crystal display device according to Embodiment 4. The figure shows a state of a voltage to be charged to the liquid crystal display element when white display with high brightness is executed.

The parts shown by dotted lines denote a state of a gate pulse and a voltage to be charged to the liquid crystal display element in the display method of the liquid crystal display device according to Embodiment 1 shown in FIG. 2. The parts shown by solid lines denote a state of a gate pulse and a voltage to be charged to the liquid crystal display element in the liquid crystal display device according to Embodiment 4.

The “predetermined voltage for black insertion data” shown in FIG. 9 means a voltage to be written in the liquid crystal display element for black data to be inserted for preventing transferring from the bend alignment to the spray alignment. If the liquid crystal display element is charged to the predetermined voltage value for the black data, transferring from the bend alignment to the spray alignment can be prevented. As a width of a gate pulse during the black writing period is wide in both cases of the liquid crystal display device according to Embodiment 1 and the liquid crystal display device according to Embodiment 4, the liquid crystal display element is charged to the “predetermined voltage for black insertion data” in both cases.

The “predetermined voltage for white data” shown in FIG. 9 means a voltage to be written in the liquid crystal display element for white display data. If the liquid crystal display element is charged to the “predetermined voltage for white data” value in a period during which a gate pulse is generated during the video writing period, white display is provided with normal brightness.

As the electric potential difference between black electric potential charged to the liquid crystal display element during the black writing period and the “predetermined voltage for white data” is wide compared with the electric potential difference against an electric potential of display data with low brightness such as black, a charging time for making the electric potential reach that required for the display data becomes long in the case of display data with high brightness such as white.

In the display method of the liquid crystal display device according to Embodiment 1, the liquid crystal display element is not charged to the “predetermined voltage for white data” in a period during which a gate pulse is generated during the video writing period as shown by dotted lines in FIG. 9 so that the video is illuminated by the backlight 11 and displayed with that electric potential, whereby the video is displayed with low brightness.

In contrast, in the case of the liquid crystal display device according to Embodiment 4, as the gate pulse width during the video writing period is widened as shown by a solid line of FIG. 9 and a time for charging the liquid crystal display element is extended, the liquid crystal display element can be charged nearer to the “predetermined voltage for white data” than in the liquid crystal display device according to Embodiment 1. Accordingly, display with brightness improved from that of the liquid crystal display device according to Embodiment 1 can be provided.

In Embodiment 4, as a gate pulse is generated once during the video writing period for each line, the width of a gate pulse thus generated once is an example of a total period of periods during each of which a gate signal is turned on of the present invention.

In Embodiment 4, although a gate pulse width of the video writing period is set twice a time required for writing display data for a line, the liquid crystal display element can be charged much nearer to the “predetermined voltage for white data” by widening the gate pulse width, further improving display brightness.

As shown in FIG. 8, in the liquid crystal display device according to Embodiment 4, a period during which gate signals are turned on for a plurality of scan lines at the same time occurs as a width of the gate pulse is widened in the video writing period. Influence from display data on the other lines can be reduced by writing data of the line at the end of the period during which a gate signal is turned on. If the width of the gate pulse is increased too much, the data is subject to influence from display data on the other lines. Thus, the width of the gate pulse needs to be decided in consideration of the application of the liquid crystal display device.

In the example shown in FIG. 8 of Embodiment 4, although the same data (S1) of the line as the data to be written in the latter half of the gate pulse is written in the first half of the gate pulse of the gate signal G1 which is generated during the video writing period, previously decided half tone data may be written in the first half of the gate pulse. In such a case, a pixel can be previously charged to an electric potential of half tone data nearer to the electric potential corresponding to the data (S1) of the line than the black electric potential, and thus, the same effect is obtained.

### Embodiment 5

Description will be given below of a display operation of the liquid crystal display device according to Embodiment 5 of the present invention.

The liquid crystal display device according to Embodiment 5 also has the same configuration as that of Embodiment 1, as shown in FIG. 1. Transferring of display data from the signal processing section 21 to the shift register 24 and controlling by the timing control section 22 on the gate driver 13 and the D/A converting section 23 are different from those of the liquid crystal display device according to Embodiment 4.

In FIG. 8 according to Embodiment 4, each of the total period of each of the gate signals G1 to G7 during the video writing period in a field period becomes longer than the time required for writing display data for a line by widening the width of each of the gate pulses to be generated in the video writing period.

Also in a method other than that, the same effect can be provided by making each of the total periods of each of the gate signals G1 to G7 during the video writing period in a field period longer than a time required for writing display data for a line. The liquid crystal display device according to Embodiment 5 extends each of the total periods of each of the gate signals G1 to G7 during the video writing period in a period of a field longer than a time required for writing display data for a line by generating a gate pulse in a plurality of times to cause display data to be written in a plurality of times for each scan line in a field period.

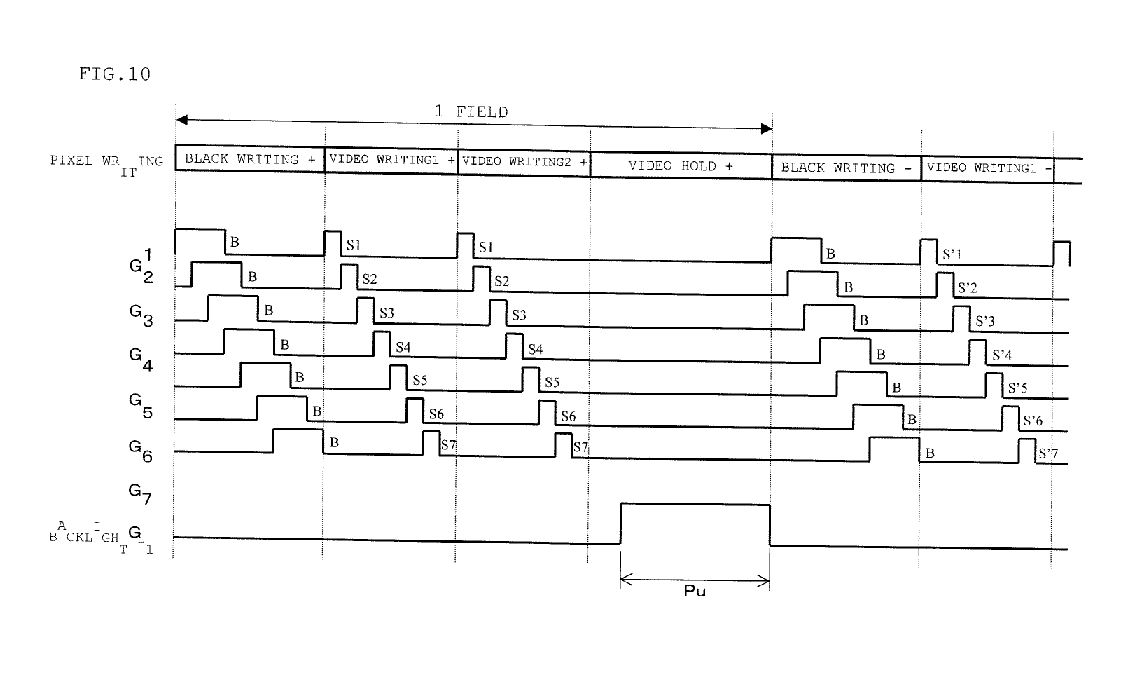

FIG. 10 shows an example of a timing chart illustrating an operation for the liquid crystal display device according to Embodiment 5 to display a video.

Description will be given below of the parts of the operation of writing in each of the liquid crystal display elements in Embodiment 5 different from that in Embodiment 4 with reference to FIG. 1 and FIG. 10.

In Embodiment 5, a period for a field (or a frame) is divided into a black writing period, a video writing first period, a video writing second period and a video HOLD period for writing to each liquid crystal display element, the black data for preventing transferring from the bend alignment to the spray alignment is written during the black writing period, and display data is written during each of the video writing first period and the video writing second period.

The video writing first period and the video writing second period are an example of the display data writing period of the present invention. The video HOLD period is an example of the display data HOLD period of the present invention.

A gate pulse is sequentially generated on each scan line during the black writing period and the black data for preventing transferring from the bend alignment to the spray alignment is written. The timing control section 22 controls the width of the gate pulse to be generated when the black data is written during the black writing period to be long enough for certainly charging the liquid crystal display element to the black electric potential.

Thereafter, a gate pulse is sequentially generated to each scan line during the video writing first period, and display data of an immediately previous field stored in the frame memory 15 is written. The width of the gate pulse to be generated when the display data is written during the video writing first period is the same time required for writing display data for a line as that of the conventional liquid crystal display device as shown in FIG. 30.

During the video writing first period, the signal processing section 21 transfers display data which has been subjected to correction in an immediately previous field to the shift register 24 again by pixels in one line according to a start pulse from the timing control section 22.

During the video writing second period, the timing control section 22 sequentially generates gate pulses to the corresponding scan lines, outputs a load pulse to the D/A converting section 23, executes the D/A conversion on the display data for a line pixel stored in the shift register 24, outputs a voltage corresponding to each display data to a signal line of the liquid crystal display panel 10, and writes display data Oman immediately previous field, which is the same as that is written during the video writing first period. The width of the gate pulse to be generated when display data is written during the video writing second period is a time required for writing display data for a line, which is the same as that in the conventional liquid crystal display device.

The same display data is written twice in each line in this manner. Insufficient writing to the liquid crystal display element is prevented from occurring also for the display data with high brightness as the same display data is written twice.

Description will be given below of a principle for reducing insufficient writing to the liquid crystal display element for display data in the liquid crystal display device according to Embodiment 5.

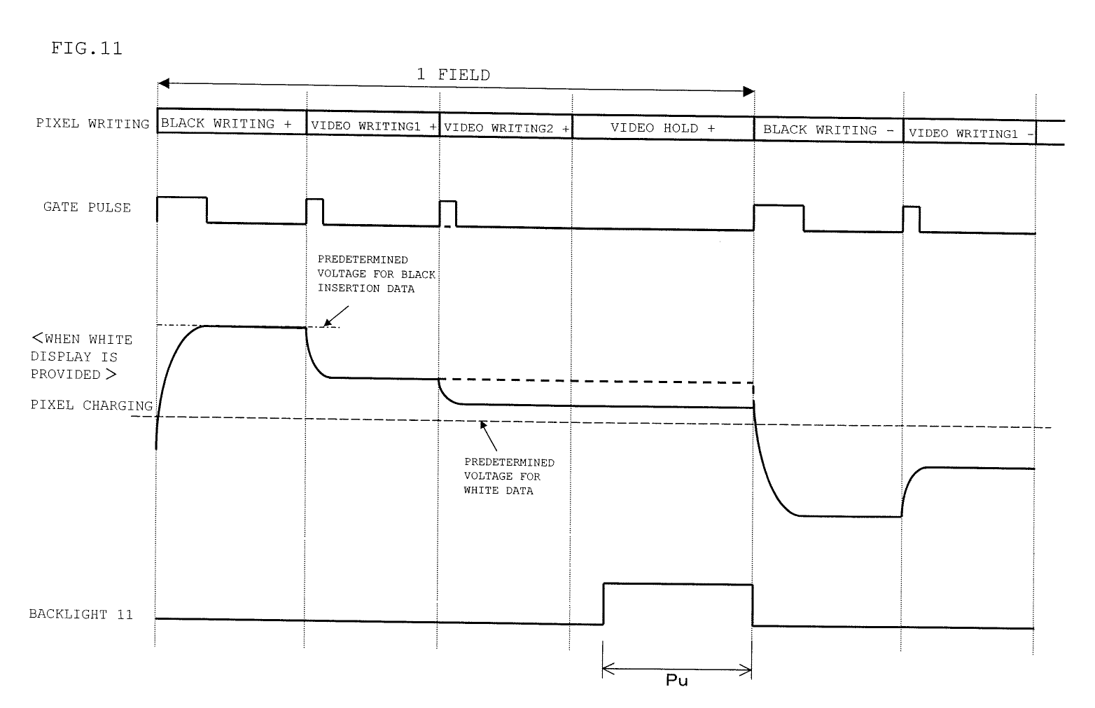

FIG. 11 shows a timing chart illustrating an operation for reducing insufficient writing to the liquid crystal display element for display data in the liquid crystal display device according to Embodiment 5. The figure shows a state of voltage to be charged to the liquid crystal display element when white display with high brightness is provided.

The part shown by a dashed line denotes a state of a gate pulse and a voltage to be charged to the liquid crystal display element in a display method of the liquid crystal display device according to Embodiment 1 shown in FIG. 2. The parts shown by solid lines denote a state of a gate pulse and a voltage to be charged to the liquid crystal display element in the liquid crystal display device according to Embodiment 5.

In the case of the liquid crystal display device according to Embodiment 1 and in the case of the liquid crystal display device according to Embodiment 5, a width of the gate pulse during the black writing period is wide, and thus, the liquid crystal display element is charged to the “predetermined voltage for black insertion data” in either case.

In the display method of the liquid crystal display device according to Embodiment 1, charging is executed to pixels only while a gate pulse for the video writing first period is generated as denoted by a dashed line in FIG. 11 and not executed to the “predetermined voltage for white data” only during that period. The video is illuminated by the backlight with that electric potential and displayed, and thus, the video is displayed with a low brightness.

In contrast, in the case of the liquid crystal display device according to Embodiment 5, an electric potential of the pixel is neared to the “predetermined voltage for white data” value by charging during the gate pulse period of the video writing first period as denoted by solid lines of FIG. 11, and then that electric potential is further neared to the “predetermined voltage for white data” by charging during the gate pulse periods of the two video writing periods. That enables the video with improved brightness comparing with that by the conventional liquid crystal display device.

Although the same display data is written twice in each field period in Embodiment 5, the same display data may be written for three times or more.

The same display data may also be written during the video HOLD period for lighting the backlight 11.

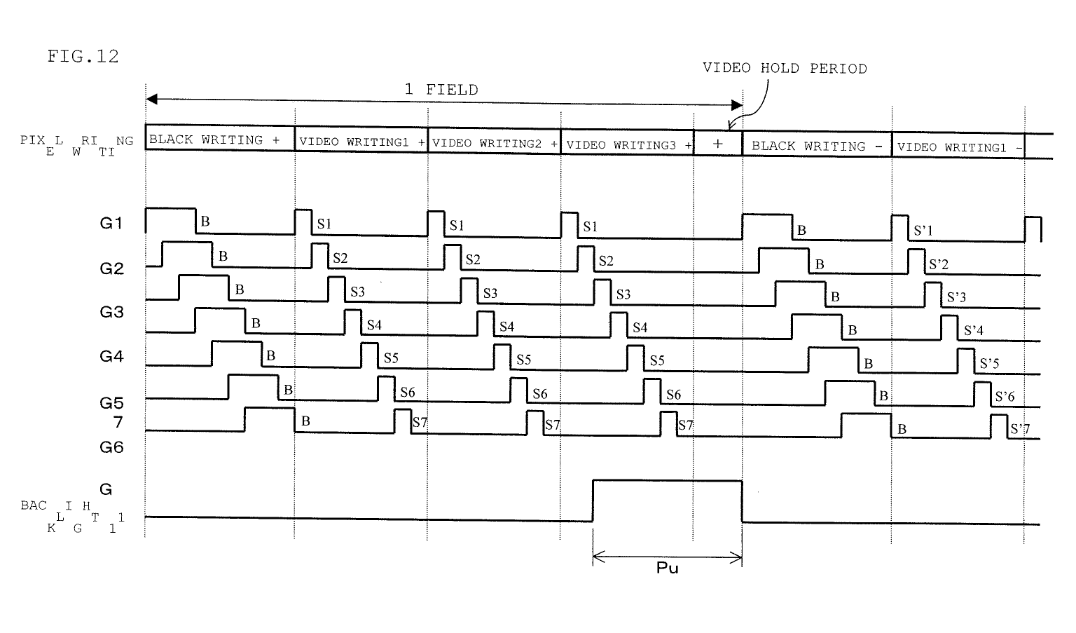

FIG. 12 shows a timing chart illustrating an operation where the same display data is written for three times for each line including a period during which a backlight is lit in the liquid crystal display device according to Embodiment 5.

With the same operation as described in FIG. 10, the same display data as that written during the video writing first period and the video writing second period is written in during a video writing third period.

By charging during a gate pulse period to be generated during the video writing third period, the electric potential of a pixel can be charged much nearer to the “predetermined voltage for white data”. That enables the video to be displayed with much improved brightness than in the case of FIG. 10.

Here, although the backlight 11 lights during the video writing third period, the same display data as that written during the video writing second period before the backlight 11 is lit is written. There is no problem even if further writing is done during the backlight 11 lights.

Although display data is repeatedly written three times in the example shown in FIG. 12, the time to repeat writing the display data may be more if a period for sequentially writing the display data of all the lines for a field period (the length of the video writing first period or the video writing second period) can further be shorten.

If only insufficient charging for the display data to be finally written can be avoided, data repeatedly written may not necessarily be the same display data. For example in the case of FIG. 10, predetermined data with middle brightness only needs to be written during the video writing first period so that the writing of the data of middle brightness previously charges to raise the electric potential charged in the pixel at the start point of writing the display data for the video writing second period as high as the electric potential which does not cause insufficient charging on the writing of the display data of the video writing second period.

### Embodiment 6

Description will be given below of a display operation of the liquid crystal display device according to Embodiment 6 of the present invention.

The liquid crystal display device according to Embodiment 6 also has the same configuration as that of the liquid crystal display device according to Embodiment 1, as shown in FIG. 1. Controlling by the timing control section 22 on the gate driver 13 and the D/A converting section 22 is different from that of the liquid crystal display device according to Embodiments 4 and 5.

The liquid crystal display device according to Embodiment 6 generates a gate pulse for a plurality of times on each scan line and writes display data for a plurality of times in a field period, and widens the width of each gate pulse to be generated during the video writing period so that each of the total periods of each of the gate signals G1 to G7 during the video writing period in a field period is longer than the time required for writing display data for a line.

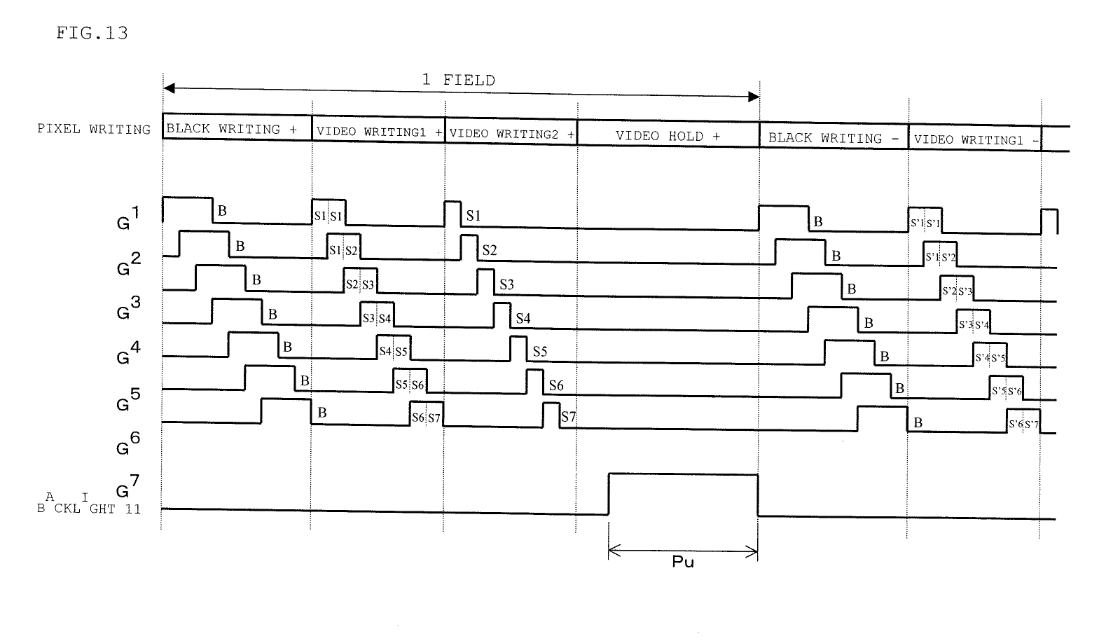

FIG. 13 shows an example of a timing chart illustrating an operation for the liquid crystal display device according to Embodiment 6 to display a video.

Description will be given below of parts of the operation of writing to each liquid crystal display element in the liquid crystal display device according to Embodiment 6 different from those by the liquid crystal display device according to Embodiment 5 with reference to FIG. 1 and FIG. 13.

In Embodiment 6, a period of a filed (or a frame) is divided into a black writing period, a video writing first period, a video writing second period and a video HOLD period for writing to each of the liquid crystal display elements, black data for preventing transferring from the bend alignment to the spray alignment is written during the black writing period, and the display data is written during each of the video writing first period and the video writing second period. They are the same as those in the case of the liquid crystal display device according to Embodiment 5 shown in FIG. 10.

First, a gate pulse is sequentially generated in each of the scan lines and black data for preventing transferring from the bend alignment to the spray alignment is written during the black writing period. The timing control section 22 controls the width of the gate pulse to be generated when black data is written during the black writing period so that the width is long enough to certainly charge the liquid crystal display element to the black electric potential.

Then, a gate pulse is sequentially generated to each of the scan lines during the video writing first period and display data of an immediately previous field stored in the frame memory 15 is written. The width of the gate pulse to be generated when display data is written during the video writing first period is longer than the time required for writing the display data for a line. The width of the gate pulse to be generated during the video writing first period is set twice the period required for writing the display data for a line. Only that the width of the gate pulse to be generated during the video writing first period is increased is different from the case of Embodiment 5 shown in FIG. 10.

The timing control section 22 sequentially generates gate pulses to each of the scan lines during the video writing second period, outputs a load pulse to the D/A converting section 23, executes the D/A conversion on the display data for a line pixel stored in the shift register 24, and outputs a voltage corresponding to each display data to a signal line of the liquid crystal display panel 10 to write the same display data of an immediately previous field as that written during the video writing first period. The width of the gate pulse to be generated when display data is written during the video writing second periods is the same time required for writing display data for a line as that for the conventional liquid crystal display device shown in FIG. 30.

The same display data is written twice for each line in this manner with the width of the gate pulse to be generated when the display data is written during the video writing first period being longer than the period required for writing display data for a line.

Description will be given below of a principle for reducing insufficient writing to the liquid crystal display element for display data in the liquid crystal display device according to Embodiment 6.

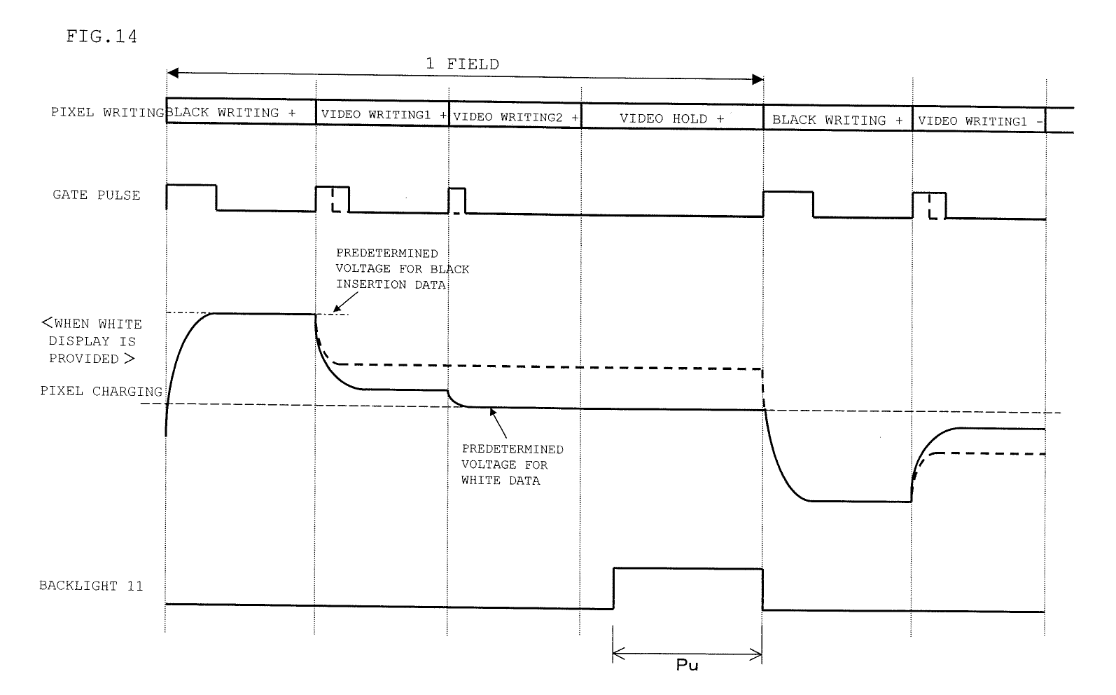

FIG. 14 shows a timing chart illustrating an operation for reducing insufficient writing to liquid crystal display element for display data in the liquid crystal display device according to Embodiment 6. The figure shows a state of a voltage to be charged to the liquid crystal display element when white display with high brightness is provided.

The part shown by a dashed line denotes a state of a gate pulse and a voltage to be charged to the liquid crystal display element in the display method of the liquid crystal display device according to Embodiment 1 shown in FIG. 2. The parts shown by solid lines denote a state of a gate pulse and a voltage to be charged to the liquid crystal display element in the liquid crystal display device according to Embodiment 6.

In the case of the liquid crystal display device according to Embodiment 1 and the case of the liquid crystal display device according to Embodiment 6, the liquid crystal display element is charged to the “predetermined voltage for black insertion data” in both cases as the width of the gate pulse during the black writing period is wide.

In the display method of the liquid crystal display device according to Embodiment 1, charging is executed to pixels only while a gate pulse for the video writing first period is generated as denoted by a dashed line of FIG. 14 and not executed to the “predetermined voltage for white data” only during that period. The video is illuminated by the backlight with that electric potential and displayed, and thus, the video is displayed with low brightness.

In contrast, in the case of the liquid crystal device according to Embodiment 6, the electric potential of a pixel is neared to the “predetermined voltage for white data” value by charging during the gate pulse period of the video writing first period, then that electric potential is further neared to the “predetermined voltage for white data” by charging during the gate pulse period of the video writing second period, as denoted by solid lines of FIG. 14.

As the width of the gate pulse to be generated during the video writing first period is increased, a pixel can be charged much nearer to the “predetermined voltage for white data” than in the case of the liquid crystal display device according to Embodiment 5 during the gate pulse is generated. As the backlight 11 is lit in a state where the pixel is charged much nearer to the “predetermined voltage for white data” than that of the liquid crystal display device according to Embodiment 5, the video can be displayed by further suppressing the brightness lowering.

In the case of the sixth embodiment, the width of the gate pulse for the video writing first period may also be much longer or the width of the gate pulse of the video writing second period may be longer as in the case of the Embodiment 4. Display data may be repeatedly written three times or more or display data may be written even a period during which a backlight is lit as in the case of the Embodiment 5. If insufficient writing does not occur for the display data written last, the data to be repeatedly written may not be the same display data.

As mentioned above, the driving method of the liquid crystal display device according to Embodiments 4 to 6 can implement the liquid crystal display device, which can display the video without lowering its brightness even at the low temperature, as it increases a period for charging electric power for display data and charge it near to a voltage value much near to the voltage value required for the display data by extending the total period during which each gate signal of each line is turned on.

As the total period during which each gate signal of each line is turned on in a period of a field or a frame is the longer, the more certainly the liquid crystal display element can be charged near to the voltage required for the display data. The more the time to repeat writing the display data, the more the consuming power is. A driving method appropriate for the liquid crystal display device may be used by deciding the gate pulse width in writing the display data and the number of times to repeat writing the display data in consideration of the purpose of the liquid crystal display device and the environment in which the liquid crystal display data is used.

Although a short afterglow type cold cathode-ray tube is used as a backlight in Embodiments 1 to 6, any backlight, for example a LED backlight or the like, can be applied to the present invention if it lights up rapidly.

As mentioned above, with the liquid crystal display device according to Embodiment 1 to 6 and the method for driving the liquid crystal display device, insufficient writing to the liquid crystal display element, which is caused when a voltage corresponding to the black data to be inserted for preventing transferring from the bend alignment to the spray alignment is supplied, can be reduced in the display method for causing the backlight to illuminate only while the liquid crystal display element responds to the display data.

Further with the liquid crystal display device according to Embodiments 4 to 6 and the method for driving the liquid crystal display device, a phenomenon of lowered brightness displayed at a low temperature in the liquid crystal display device according to Embodiments 1 to 3 can be improved.

### Embodiment 7

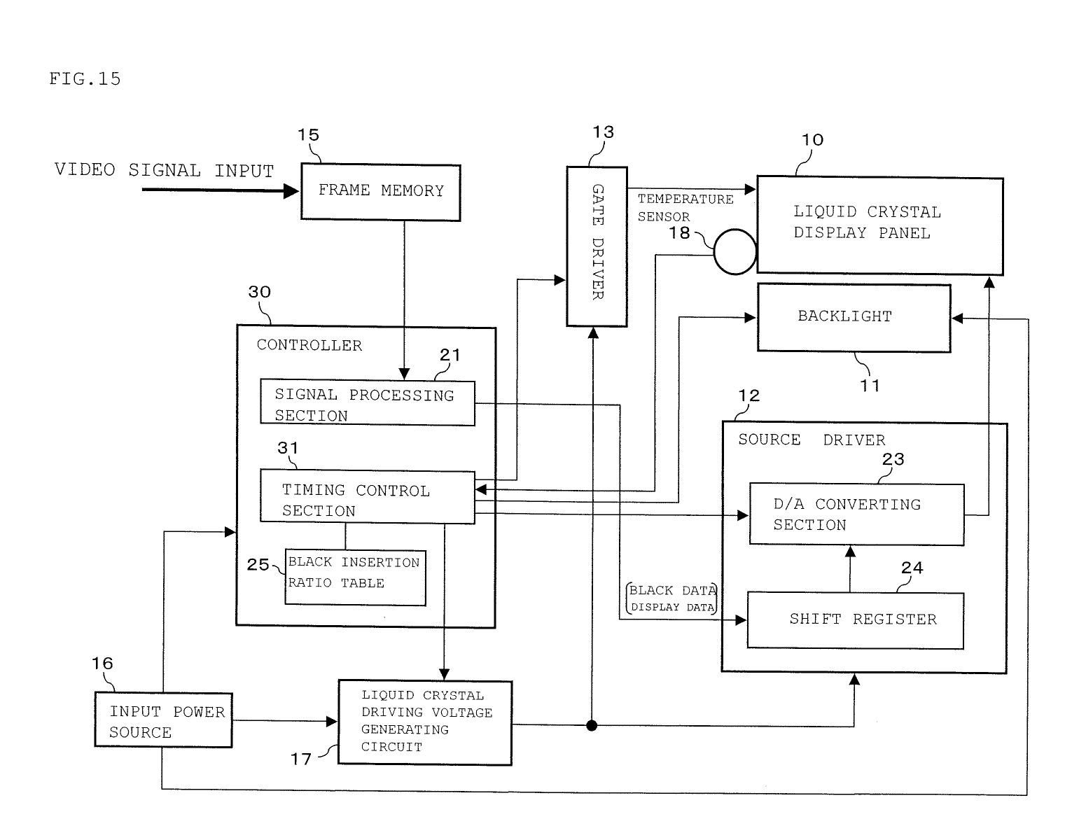

FIG. 15 is a block diagram showing a configuration of the liquid crystal display device according to Embodiment 7 of the present invention. The same components as those in the FIG. 1 are denoted by the same reference characters.

The liquid crystal display device according to Embodiment 7 comprises a liquid crystal display panel 10, a backlight 11, a source driver 12, a gate driver 13, a controller 30, a frame memory 15, an input power source 16, a liquid crystal driving voltage generating circuit 17, and a temperature sensor 18.

The liquid crystal display panel 10 comprises signal lines and scan lines arranged in a matrix and an OCB mode liquid crystal display element provided on an intersection point between them.

The backlight 11 is arranged at the backside of the liquid crystal display panel 10 for illuminating the liquid crystal display panel 10 with a plurality of short afterglow cold cathode-ray tubes.

The frame memory 15 is a storage unit which temporally stores data in a field immediately before the input video signal data.

The input power source 16 supplies power to the backlight 11, the controller 30 and the liquid crystal driving voltage generating circuit 17. The liquid crystal driving voltage generating circuit 17 adjusts voltages to be supplied to the source driver 12 and the gate driver 13 when the display data is displayed on the liquid crystal display panel 10.

The gate driver 13 supplies gate signals to the scan lines of the liquid crystal display panel 10. The source driver 12 supplies a voltage corresponding to the display signal to each signal line of the liquid crystal display panel 10.

The temperature sensor 18 detects a temperature of the liquid crystal display panel 10 and informs the controller 30 of the temperature. The temperature sensor 18 is an example of a temperature detecting unit of the present invention.

The controller 30 comprises a signal processing section 21, a timing control section 31 and a black insertion ratio table 25. The source driver 12 comprises a D/A converting section 23 and a shift register 24. The timing control section 31 controls an output timing of a voltage to be supplied by the source drive 12 and the gate driver 13, and controls ON/OFF of the backlight 11. The timing control section 31 is an example of a timing control unit of the present invention.

Description will be given below of a display operation of the liquid crystal display device according to Embodiment 7 with reference to FIG. 15.

The video signal, which is RGB data, is temporally stored in the frame memory 15.

The signal processing section 21 of the controller 30 reads immediately previous field data stored in the frame memory 15 and executes gray scale correction or gamma correction on the video signal. Then, the signal processing section 21 transfers display data, which has been subjected to the correction, to the shift register 24 of the source driver 12 by pixels in one line according to a start pulse from the timing control section 31.

The signal processing section 21 also transfers black data for preventing transferring from the bend alignment to the spray alignment to the shift register 24 by pixels in one line according to a start pulse from the timing control section 31.

The timing control section 31 outputs a load pulse indicating a black data writing start timing to the liquid crystal display element and a load pulse indicating a display data writing start timing to the liquid crystal display element to the D/A converting section 23 of the source driver 12. If a temperature of the liquid crystal display panel 10 detected by the temperature sensor 18 is at a predetermined temperature or more, the timing control section 31 decides the display data writing start timing to the liquid crystal display element from the temperature of the liquid crystal display panel 10 by referring to the black insertion ratio table 25, and outputs a load pulse matching the timing.

The black data writing start timing means a timing when a voltage corresponding to black data starts to be supplied from the source driver 12 to the liquid crystal display element in the black writing period, which is an example of the black data writing start timing of the present invention.

The display data writing start timing means a timing when a voltage corresponding to display data starts to be supplied from the source driver 12 to the liquid crystal display element in the video writing period, which is an example of the display data writing start timing of the present invention.

In the case of FIG. 30, as the gate signal G1 of the liquid crystal display element shown at the top is turned on first, a timing to start supplying a voltage for black data and display data to the top liquid crystal display element is the black data writing start timing and the display data writing start timing. In the case of FIG. 30, as wring to the liquid crystal display element shown at the top starts at the beginning of the black writing period and the video writing period, the beginning of the black writing period and the beginning of the video writing period are the black data writing start timing and the display data writing start timing, respectively.

The D/A converting section 23 obtains data stored in the shift register 24 for pixels in one line at a time when the load pulse is input from the timing control section 31, executes the D/A conversion on the data, and outputs a voltage corresponding to the black data or a voltage corresponding to each display data to the corresponding signal line of the liquid crystal display panel 10.

The timing control section 31 controls an output timing of the gate signal to be output from the gate driver 13 to the corresponding scan line, and controls ON/OFF of the backlight 11.

Description will be given below of a deciding method of the display data writing start timing to the liquid crystal element in the liquid crystal display device according to Embodiment 7 of the present invention.

The timing control section 31 uses a predetermined timing preset as a display data writing start timing when a temperature of the liquid crystal display panel 10 detected by the temperature sensor 18 is less than a predetermined temperature.

When the temperature of the liquid crystal display panel 10 is the predetermined temperature or more, the timing control section 31 decides the display data writing start timing from the temperature of the liquid crystal display panel 10 by referring to the black insertion ratio table 25.

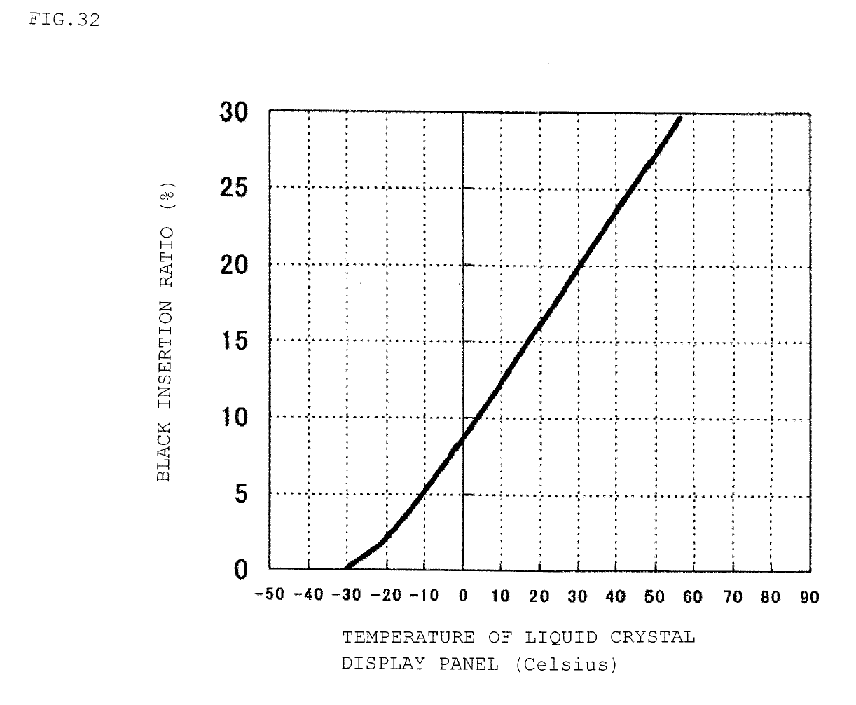

In the black insertion ratio table 25, information indicating relationship between the temperature of the liquid crystal display panel 10 and black insertion ratio appropriate for the temperature is stored. Thus, it is such information as shown in FIG. 32. The black insertion ratio that does not cause transferring from the bend alignment to the spray alignment at the temperature can be obtained from the temperature of the liquid crystal display panel 10 by using the black inserting ratio table 25.

The timing control section 31 obtains the black insertion ratio required for avoiding transferring from the bend alignment to the spray alignment at the temperature from the temperature of the liquid crystal display panel 10 detected by the temperature sensor 18 by referring to the black insertion ratio table 25. Then, the timing control section 31 decides the display data writing start timing such that a period during which black data is written to and kept in the liquid crystal display element at the obtained black insertion ratio or more.

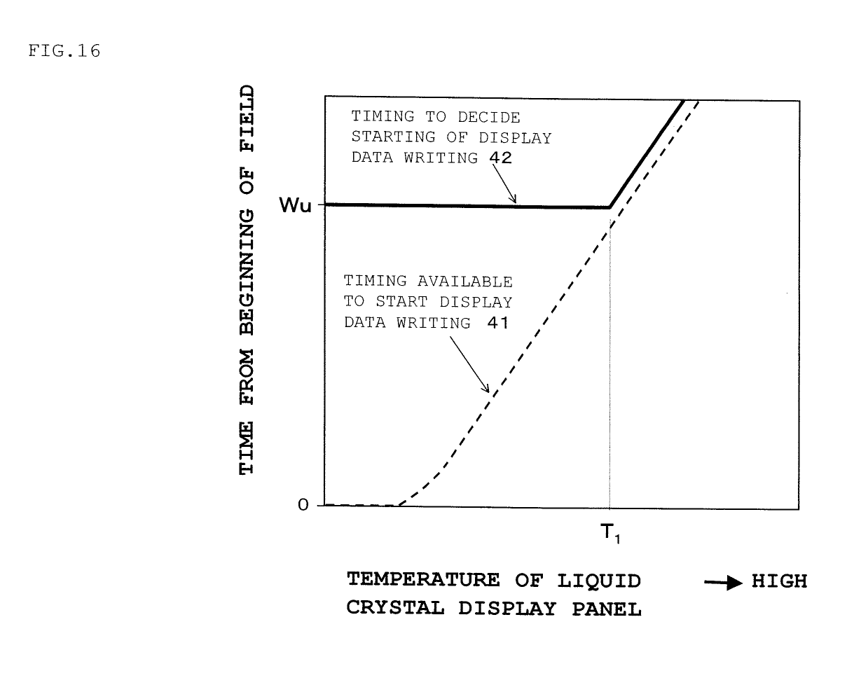

FIG. 16 shows relationship between the temperature of the liquid crystal display panel 10 and the display data writing start timing decided by the timing control section 31. The part shown by a solid line shows the timing to decide starting of display data writing 42 decided by the timing control section 31. The part shown by a dashed line shows timings available to start display data writing 41, at which the video can be displayed without transferring from the bend alignment to the spray alignment. If writing of display data starts after the timing available to start display data writing 41 corresponding to each temperature, transferring from the bend alignment to the spray alignment does not occur. In FIG. 16, the timing available to start display data writing 41 and the timing to decide starting of display data writing 42 are shown by time periods from the respective beginnings of the field.

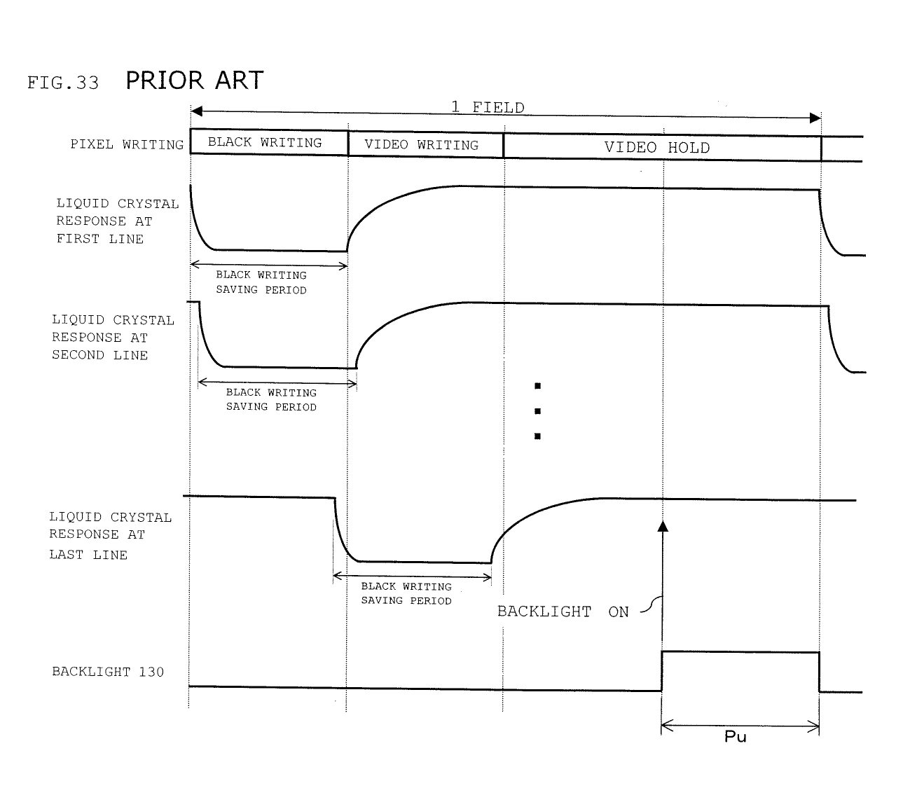

The timing available to start display data writing 41 of FIG. 16 can be obtained from the black insertion ratio required for the temperature. In FIG. 33, a proportion of the black writing saving period for a field period is the black insertion ratio. The timing when the display data is started to be written in the liquid crystal display element at the first line is the timing to end black writing (=timing to start video writing period), and thus, a period from the beginning of the field to the display data writing start timing is equal to the period for saving black writing. Therefore, the timing available to start display data writing 41 shown in FIG. 16 can be obtained from the black data writing start timing and the black insertion ratio.

Therefore, relationship between the temperature of the liquid crystal display panel 10 and the timing available to start display data writing 41 is the same curve as that of the relationship between the temperature of the liquid crystal display panel 10 shown in FIG. 32 and the black insertion ratio as shown in FIG. 16.

Then, the timing control section 31 obtains the timing to decide starting of display data writing 42 from the timing available to start display data writing 41 obtained from the black insertion ratio table 25. When the temperature of the liquid crystal display panel 10 is a predetermined temperature T₁ or more, the timing to decide starting of display data writing 42 is decided to be a timing after the timing available to start display data writing 41 as shown in FIG. 16. The predetermined temperature T₁ is an example of a predetermined temperature of the present invention.

In FIG. 16, although the timing to decide starting of display data writing 42 is little bit after the timing available to start display data writing 41, it may be the same as the timing available to start display data writing 41.

The reference character Wu shown in FIG. 16 is the display data writing start timing used in a normal temperature in a normal environment such as an ambient temperature and the above mentioned preset timing.

In Embodiment 7, for example, if the temperature of the liquid crystal display panel 10 and the black insertion ratio has the relationship shown in FIG. 32, as a black writing period is 25% of a field period, the display data writing start timing Wu used at the ambient temperature is a timing at ¼ field period and the black insertion ratio needs to be 25% or more when the temperature of the liquid crystal display panel 10 is about 45 degrees Celsius or more, and thus, the predetermined temperature T₁ only needs to be approximately 40 degrees Celsius. In such a case, when the temperature of the liquid crystal display panel 10 is less than 40 degrees Celsius, the liquid crystal display device is driven at the display data writing start timing Wu so that the black insertion ratio is 25% or more; and when the temperature is at 40 degrees Celsius or more, the liquid crystal display device is driven at a display data writing start timing after the Wu so that necessary black insertion ratio at 25% or more can be obtained.

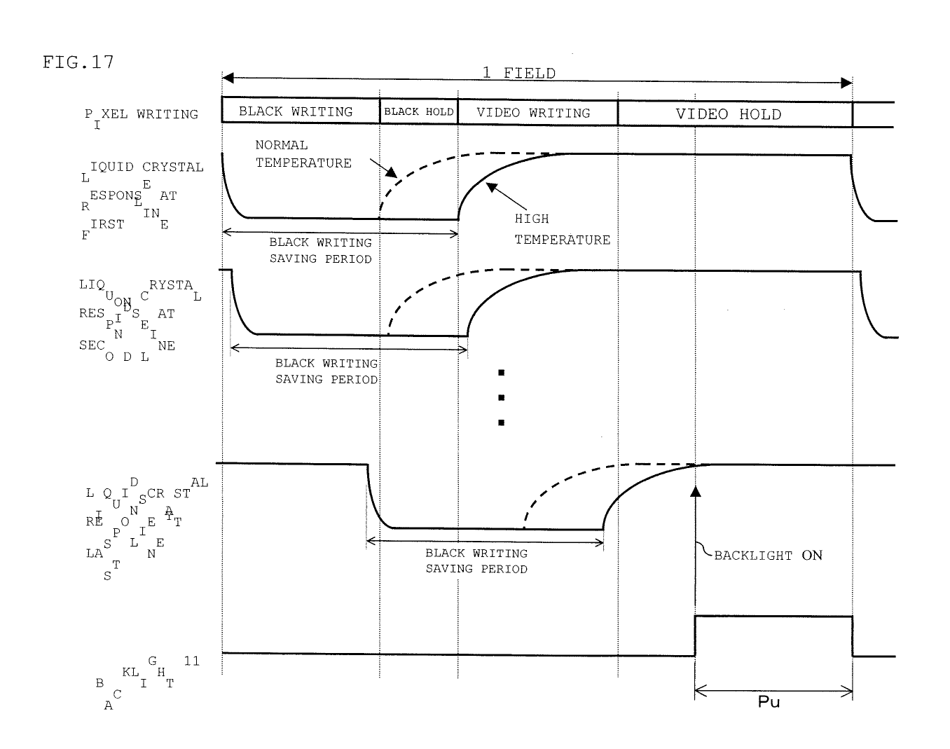

FIG. 17 shows a timing chart illustrating a responding state of each liquid crystal display element at a high temperature of the liquid crystal display device according to Embodiment 7.

The solid lines show a responding state of each liquid crystal display element at a high temperature and the dashed lines show a responding state of each liquid crystal display element at a normal temperature that is a temperature of a normal environment such as an ambient temperature.

The term “at high temperature” shown in FIG. 17 means that a temperature of the liquid crystal display panel 10 exceeds the predetermined temperature T₁ shown in FIG. 16, which is controlled by the timing control section 31 so that the display data writing start timing is after that at the normal temperature.

The black HOLD period shown in FIG. 17 means the period which the display data writing start timing is delayed from that at the normal temperature. As black data has been written in all the liquid crystal display elements during the black writing period shown in FIG. 17, every gate line is turned OFF during the black HOLD period.

Thus, the length of a period during which a state of the black data written in each liquid crystal display element is saved at a high temperature is the length of the black writing period+the black HOLD period, which is longer than that of only the black writing period at a normal temperature. Therefore, the black insertion ratio is also higher than that of the normal temperature.

As such, in the liquid crystal display device according to Embodiment 7, display data is written in the liquid crystal display device at a timing to increase the black insertion ratio by delaying the display data writing start timing at a high temperature so that occurrence transferring from the bend alignment to the spray alignment can be certainly avoided.

The timing control section 31 decides the display data writing start timing by using the black insertion ratio table 25 that stores the information shown in FIG. 32 in Embodiment 7, but a table including information on relationship between the temperature of the liquid crystal display panel 10 and the timing available to start display data writing 41 as shown in FIG. 16 may be used instead of the black insertion ratio table 25.

The timing control section 31 decides the display data writing start timing by using the black insertion ratio table 25 only when the temperature is at a predetermined temperature T₁ or more in Embodiment 7, but may use a table including information on relationship between the temperature of the liquid crystal display panel 10 and the timing to decide starting of display data writing 42 as shown in FIG. 16 instead of the black insertion ratio table 25 to decide the display data writing start timing from the table for all the temperature ranges without limiting it to the predetermined temperature T₁ or more.

The timing control section 31 decides the display data writing start timing, which sequentially changes against a change in the temperature of the liquid crystal display panel 10 by using the black insertion ratio table 25 at the predetermined temperature T₁ in Embodiment 7, but a temperature range at the predetermined temperature T₁ or more may divided into a plurality of groups of temperature ranges with the display data writing start timing being associated with a changes in a temperature of the liquid crystal display panel 10 for each group so as to decide the display data writing start timing stepwise.

The display data writing start timing is decided by using the black insertion ratio table 25 in Embodiment 7, but the display data writing start timing may be calculated by using the expression for obtaining the timing from the temperature of the liquid crystal display panel 10 instead of from the black insertion ratio table 25.

### Embodiment 8

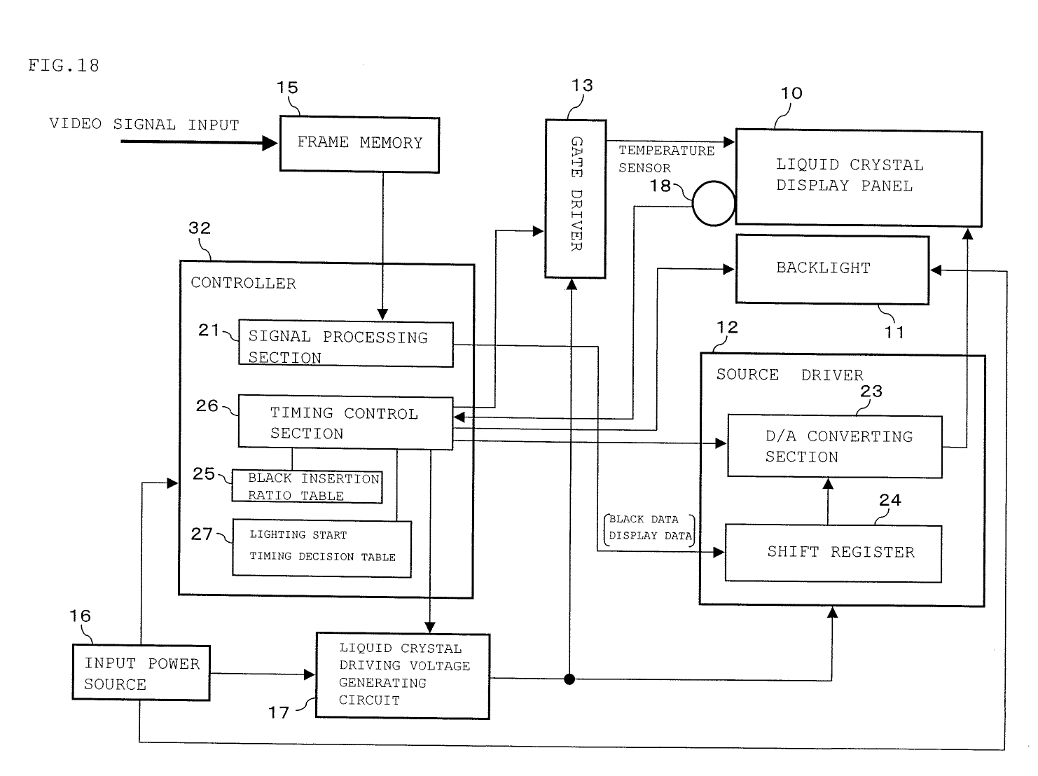

FIG. 18 is a block diagram showing a configuration of the liquid crystal display device according to Embodiment 8 of the present invention.

The liquid crystal display device according to Embodiment 8 is different from that of Embodiment 7 shown in FIG. 15 in that the controller 32 further comprises a timing to start lighting decision table 27. The same components as those in the liquid crystal display device according to Embodiment 7 shown in FIG. 15 are denoted by the same reference characters.

The liquid crystal display device according to Embodiment 8 further comprises a function of controlling an illuminating period of the backlight 11 according to the temperature of the liquid crystal panel 10 in addition to the function of that of Embodiment 7, which controls the display data writing start timing according to the temperature of the liquid crystal display panel.

First, prior to describe an operation of the liquid crystal display device according to Embodiment 8, an operation of the liquid crystal display device according to Embodiment 7 under much higher temperature will be described.

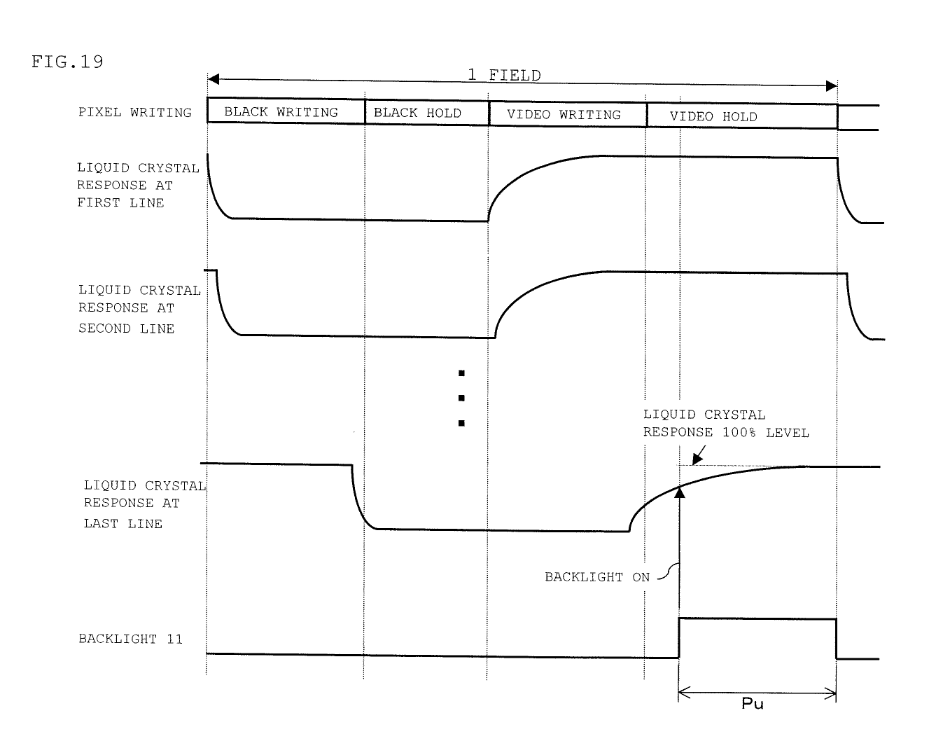

FIG. 19 shows a timing chart illustrating a responding state of each liquid crystal display element at a temperature much higher than that of the liquid crystal display device according to Embodiment 7.

As the temperature of the liquid crystal display panel 10 detected by the temperature sensor 18 is much higher than in the case of FIG. 17, the display data writing start timing is controlled to be delayed further as shown in FIG. 19, also making the black HOLD period longer.

Transferring from the bend alignment to the spray alignment can certainly be prevented as the display data writing start timing is controlled to be much delayed in this manner, but since the length of the illuminating period Pu and the timing of the backlight 11 during a field period are unchanged, a period from when the display data is written till the backlight 11 starts to light shortens as the display data writing start timing delays.

On the other hand, as writing of display data to the liquid crystal display element on the corresponding scan line during the video writing period is sequentially executed as shown in FIG. 30, the liquid crystal display element of each line sequentially starts to respond as shown in FIG. 17 or FIG. 19 such that the responding timing differs for each line. In the case of FIG. 17 and FIG. 19, the liquid crystal display element at the first line responds earliest and the liquid crystals display element at the last line responds last.

In the case of FIG. 17, as the liquid crystal display elements on all the lines has already started at the time to start lighting the illuminating period Pu, the video without uneven brightness is displayed on the whole screen of the liquid crystal display panel 10.

In the case of FIG. 19 under a higher temperature than that of the FIG. 17, however, as the liquid crystal display elements at the first line and the second line have already started responding but the liquid crystal display elements at the last line have not started at the time to start lighting the illuminating period Pu. Thus, the first line and the second line are displayed with a normal brightness but the last line is displayed darker. In such a case, the liquid crystal display panel 10 displays with uneven brightness.

The liquid crystal display device according to Embodiment 8 displays without such uneven brightness even if the display data writing start timing is controlled to delay at a high temperature.

Description will be given below of an operation for displaying without uneven brightness at a high temperature of the liquid crystal display device according to Embodiment 8. The display data writing start timing for preventing transferring from the bend alignment to the spray alignment at a high temperature is controlled in Embodiment 8 also in the same method as that of the liquid crystal display device according to Embodiment 7.

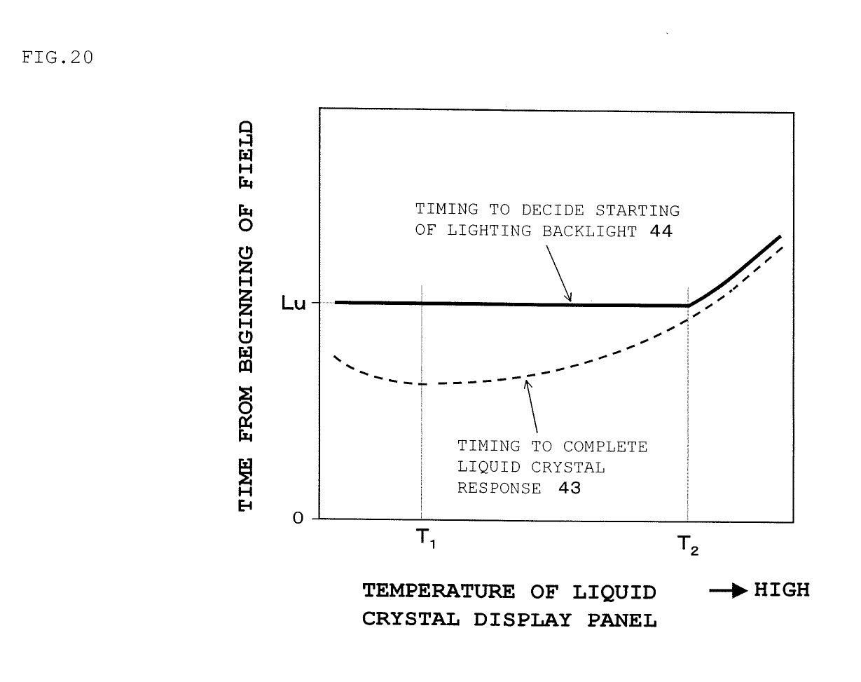

FIG. 20 shows relationship between a temperature of the liquid crystal display panel 10 and a timing to start lighting a backlight 11.

The timing to complete liquid crystal response 43 denoted by a dashed line in FIG. 20 means a timing for all the liquid crystal display elements have started responding. In the case of Embodiment 8, as the timing of writing to the liquid crystal display element at the last line is the last, the timing to complete liquid crystal response 43 is the timing at which response of the liquid crystal display element at the last line has started. If the backlight 11 is started to light after the timing to complete liquid crystal response 43, all the liquid crystal display elements on each line can be displayed with the same brightness.

The timing to complete liquid crystal response 43 is an example of a timing to start lighting a backlight required for the detected temperature of the liquid crystal display panel.

The timing to decide starting of lighting a backlight 44 denoted by a solid line in FIG. 20 means a timing at which the backlight 11 of the liquid crystal display device according to Embodiment 8 is lit. In FIG. 20, both the timing to complete liquid crystal response 43 and the timing to decide starting of lighting a backlight 44 are shown by time periods from the beginning of the field.

A timing at which a response voltage value of the liquid crystal display element reaches 90% or more is referred as a timing at which the liquid crystal response has started.

As described with reference to FIG. 16 in Embodiment 7, when the temperature of the liquid crystal display panel 10 is less than the predetermined temperature T1, writing to the liquid crystal display element starts at the same display data writing start timing Wu at any temperature. Thus, as a responding speed of the liquid crystal is faster at a higher temperature, the timing to complete liquid crystal response 43 becomes earlier at a higher temperature in a temperature range in which the temperature of the liquid crystal display panel 10 is less than T₁ as shown in FIG. 20.

The display data writing start timing is controlled to be delayed as the temperature becomes higher, when the temperature of the liquid crystal display panel 10 is T₁ or more, and thus, the timing at which the liquid crystal response has started is also delayed by the delayed time. Thus, when the temperature of the liquid crystal display panel 10 increases to T₁ or more, the timing to complete liquid crystal response 43 is delayed at the higher temperature as shown in FIG. 20.

The reference character Lu in FIG. 20 denotes a previously set timing to start lighting the backlight 11, which is used in a normal environment. The reference character Lu is a timing at which the illuminating period Pu shown in FIG. 19 starts lighting. As the illuminating period Pu of the backlight 11 is the last 25% period of a field period in Embodiment 8. Thus, Lu is a timing indicating the time point 75% from the top of a field period.

In FIG. 20, if the backlight 11 is started to light at the timing to start lighting the backlight Lu in a temperature range in which the timing to start lighting the backlight Lu is earlier than the timing to complete liquid crystal response 43, the backlight 11 starts to light before the liquid crystal response has started. If the backlight 11 starts lighting at the timing to start lighting the backlight Lu in the temperature range in which the temperature of the liquid crystal display panel 10 is at T₂ or more, display with uneven brightness is provided on the liquid crystal display panel 10.

When the temperature of the liquid crystal display panel 10 is T₂ or more, the display without uneven brightness can be provided if the backlight 11 starts to be lit at the timing after the timing to complete liquid crystal response 43. That is to say, in the temperature range of T₂ or more, the backlight 11 only needs to start to be lit at the timing to decide starting of lighting a backlight 44, which is after the timing to complete liquid crystal response 43.

The temperature range of T₂ or more is an example of a predetermined temperature range of the present invention. The timing to start lighting the backlight Lu is an example of a predetermined lighting timing of the present invention.

The timing to start lighting decision table 27 shown in FIG. 18 stores information indicating relationship between the temperature of the liquid crystal display panel 10 and the timing to decide starting of lighting a backlight 44 shown in FIG. 20 corresponding to respective temperatures.

The timing control section 26 of FIG. 18 obtains a timing to start lighting the backlight 11 for the temperature from the temperature of the liquid crystal display panel 10 detected by the temperature sensor 18 and controls the backlight 11 to start lighting at the timing.

When the temperature of the liquid crystal display panel 10 is less than T₂, the timing control section 26 obtains the timing to start lighting the backlight Lu and starts the backlight 11 to light at that timing. When the temperature of the liquid crystal display panel 10 is T₂ or more, the timing control section 26 obtains the timing to decide starting of lighting a backlight 44 corresponding to the temperature of the liquid crystal display panel 10 and starts the backlight 11 to light at that timing.

The timing control section 26 that controls ON/OFF of the backlight 11 is an example of the backlight control unit of the present invention.

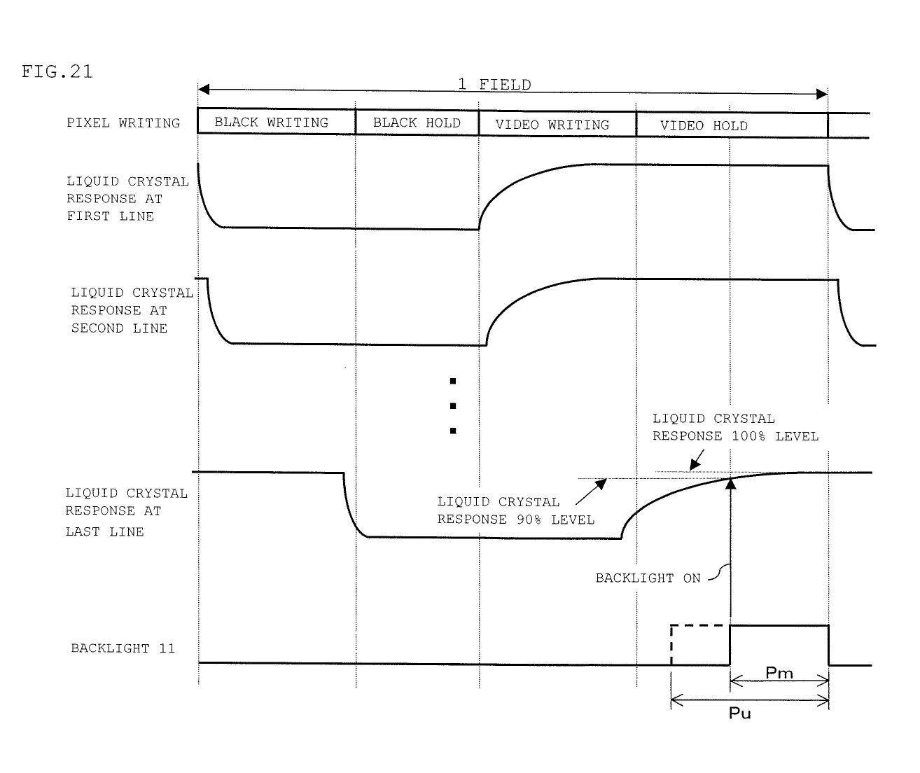

FIG. 21 shows a timing chart illustrating a responding state of each liquid crystal display element at a high temperature described in FIG. 19 of the liquid crystal display device according to Embodiment 8.

The figure shows a responding state of the liquid crystal display element on each line and a state of lighting the backlight 11. The dashed line shown in a lighting state of the backlight 11 indicates a state of the timing to start lighting the backlight according Embodiment 8 being not controlled.

At this moment, the temperature sensor 18 detects a temperature higher than T₂ shown in FIG. 20. The timing control section 26 decides the timing to start lighting the backlight 11 by using the timing to start lighting decision table 27 from the temperature detected by the temperature sensor 18 and starts the backlight 11 to light at that timing. In Embodiment 8, as a time point at which a response voltage value of the liquid crystal display element reaches 90% or more is the timing at which the liquid crystal response has started, the backlight 11 starts to light when the response voltage value of the liquid crystal display element reaches 90%.

As shown by solid lines in FIG. 21, the backlight 11 starts to light later than the timing to start the backlight to light at a normal temperature denoted by a dashed line. As a result, although the illuminating period Pm during which the backlight 11 lights is shorter than the illuminating period Pu at the normal temperature, as the liquid crystal response at the last line has also started at the timing to start the backlight 11 to light, display without unevenness can be provided on the full screen of the liquid crystal display panel 10.

In Embodiment 8, although the timing control section 26 obtains the timing to start lighting the backlight 11 by referring to the timing to start lighting decision table 27 for all the temperature ranges, as the timing to start lighting the backlight 11 Lu in the case where the temperature of the liquid crystal display panel 10 is less than T₂ is constant, the timing control section 26 may refer to the timing to start lighting decision table 27 only when the temperature of the liquid crystal display panel 10 is T₂ or more.

In Embodiment 8, although the timing to start lighting decision table 27 stores information on the timing to decide starting of lighting a backlight 44 corresponding to the temperature of the liquid crystal display panel 10 shown in FIG. 20, it may store information on the timing to complete liquid crystal response 43 corresponding to the temperature of the liquid crystal display panel 10 so that the timing control section 26 decides the timing to start lighting the backlight 11 from the information on the timing to complete liquid crystal response 43.

In Embodiment 8, although the timing to decide starting of lighting a backlight 44 stored in the timing to start lighting decision table 27 uses information which sequentially changes according to a change in the temperature of the liquid crystal display panel 10 when the temperature of the liquid crystal display panel 10 is at T₂ or more, the temperature range at T₂ or more is divided into a plurality of groups of temperature ranges, the timing to decide starting of lighting the backlight timing is set for each group for a change in the temperature of the liquid crystal display panel 10, so that the pieces of information on a change by sages for a change in the temperature of the liquid crystal display panel 10 can be used.

In Embodiment 8, although the timing to start lighting the backlight 11 is decided by using the timing to start lighting decision table 27, the timing may be calculated by using an expression for obtaining the timing to start lighting of the backlight 11 from the temperature of the liquid crystal display panel 10 instead of the timing to start lighting decision table 27.

### Embodiment 9

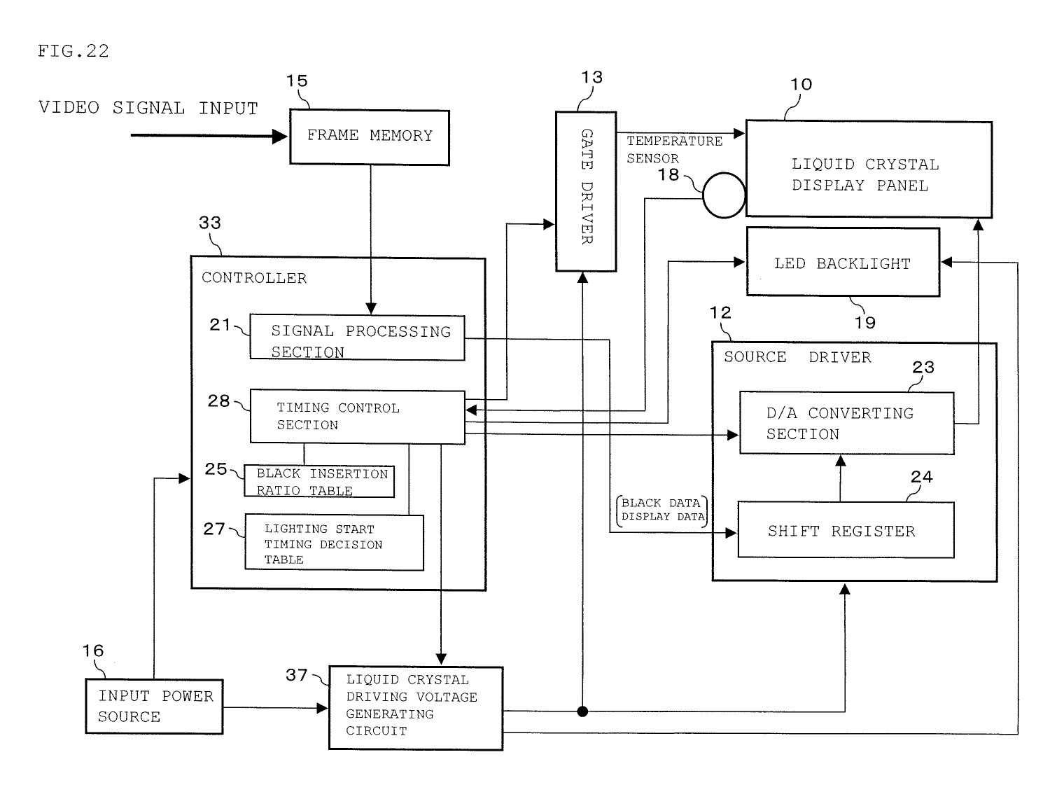

FIG. 22 is a block diagram showing a configuration of the liquid crystal display device according to Embodiment 9 of the present invention.

A liquid crystal display device of Embodiment 9 is different from that of Embodiment 8 in that a LED is used for a backlight to control a voltage to be supplied to the backlight instead of using a cold cathode-ray tube for a backlight that is used in Embodiment 8. In FIG. 22, the same components as those of the FIG. 18 are denoted by the same reference characters.

Description will be given below of things different from the liquid crystal display device according to Embodiment 8.

The LED backlight 19 is arranged at the backside of the liquid crystal display panel 10 for illuminating the liquid crystal display panel 10 with LED.

The LED backlight 19 is adapted to be supplied with a voltage from the liquid crystal driving voltage generating circuit 37. The timing control section 28 of the controller 33 has a function of controlling a voltage supplied to the LED backlight 19 by controlling the liquid crystal driving voltage generating circuit 37 in addition to the function of the timing control section 26 according to Embodiment 8.

Description will be given below of a display operation in the liquid crystal display device according to Embodiment 9.

The deciding method of the timing to start lighting the LED backlight 19 is the same as the deciding method of the timing to start lighting the backlight 11 according to Embodiment 8 shown in FIG. 18, by which the timing control section 28 decides the timing from the temperature of the liquid crystal display panel 10 detected by the temperature sensor 18 by using the timing to startlighting decision table 27.

When the timing control section 28 controls the timing to start lighting the LED backlight 19 to be delayed, it controls the liquid crystal driving voltage generating circuit 37 so that a voltage supplied from the liquid crystal driving generating circuit 37 to the LED backlight 19 increases. The timing control section 28 controls a voltage to be supplied from the liquid crystal driving voltage generating circuit 37 to the LED backlight 19 so that a current big enough for a video to be displayed with the same brightness as it is displayed during the illuminating period of Pu flows the LED backlight 19.

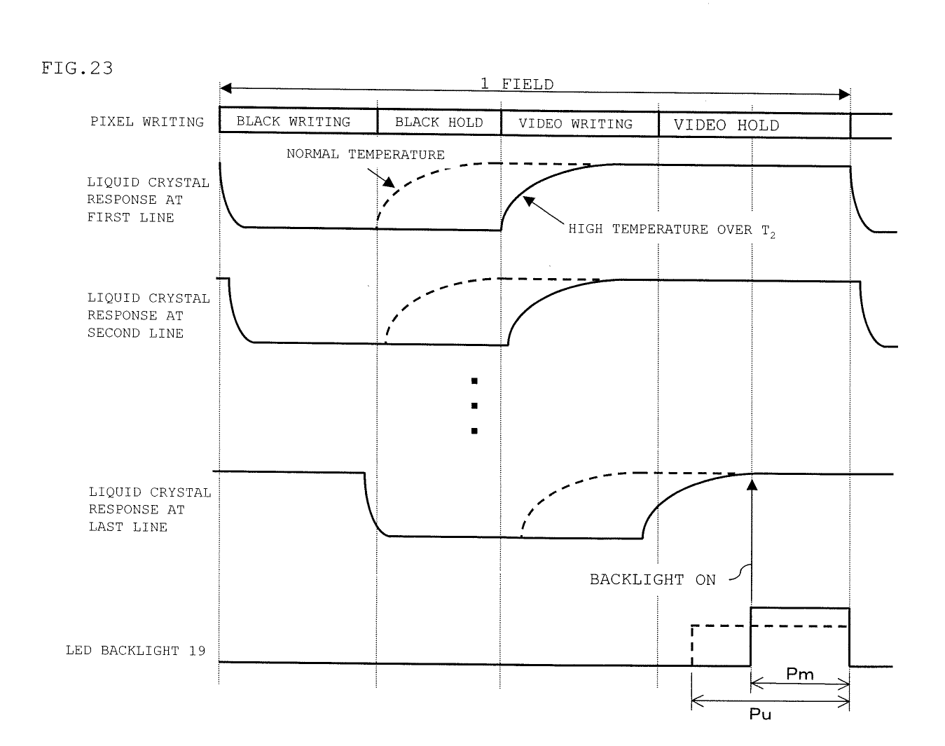

FIG. 23 shows a timing chart showing a responding state of each liquid crystal display element at a normal temperature and at a high temperature at which a temperature of the liquid crystal display panel 10 exceeds T₂ according to Embodiment 9.

The figure shows a responding state of the liquid display element on each line and a lighting state of the LED backlight 19. Dashed lines show the states at the normal temperature and solid lines showing states at a high temperature at which the temperature of the liquid crystal display panel 10 is over T₂. The difference in heights in the lighting state of the LED backlight 19 in FIG. 23 shows a difference in brightness.

As the timing to start liquid crystal response delays at a high temperature over T₂ similar to the case of Embodiment 8, the timing to start lighting the LED backlight 19 is controlled to delay. When the timing to startlighting the LED backlight 19 is controlled to delay, it is controlled to supply a voltage higher than that supplied at the normal temperature so that a current flows in the LED backlight 19 increases. As a result, the LED backlight 19 emits brighter than that does at the normal temperature as shown by solid lines.

If the timing to start lighting the LED backlight 19 delays at a high temperature over T₂, uneven brightness over the display screen can be reduced but the illuminating period Pm of the LED backlight 19 is shorter than the illuminating period Pu at a normal temperature, and thus, brightness over the display screen lowers. Embodiment 9 prevents the brightness from being lowered even when an illuminating period of the backlight is shortened by increasing a current of the backlight to emit light brighter for the short illuminating period of the backlight by using the LED for the backlight.

By using the liquid crystal display device according to Embodiment 9, the video can be displayed with neither uneven nor lowered brightness even at a high temperature.

Although a supplied voltage value is increased to increase a current flowing in the LED backlight 19 in Embodiment 9, any method can be used if only it can control the current flowing in the LED backlight 19. For example, the amount of current may be controlled as variable resistors are serially connected to the LED backlight 19 to change a resistance value when the backlight starts to light.

As mentioned above, transferring from the bend alignment to the spray alignment can be prevented even at a high temperature in the display method for causing the backlight to illuminate only during a period during which the liquid crystal display element responds to the display data, when the liquid crystal display device and the driving method of the liquid crystal display device according to Embodiments 7 to 9 is used.

### Embodiment 10

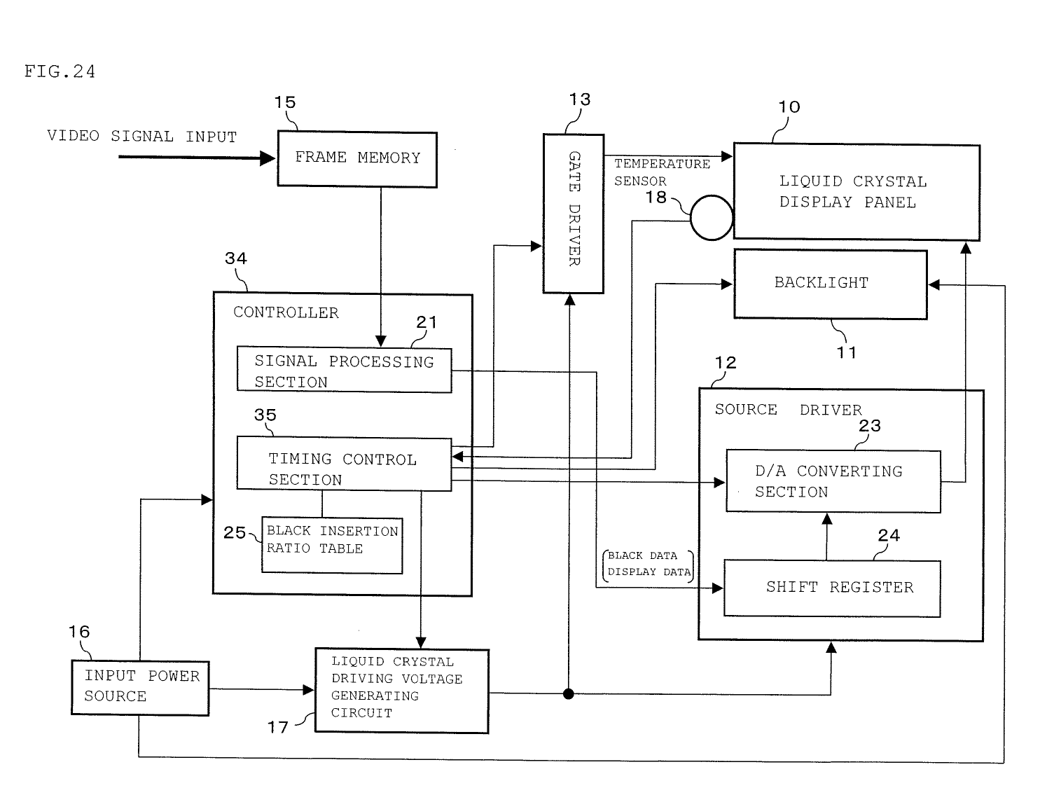

FIG. 24 is a block diagram showing a configuration of the liquid crystal display device according to Embodiment 10 of the present invention.

It has the same configuration as that of the liquid crystal display device according to Embodiment 7 shown in FIG. 15, with only differences in that the timing control section 35 of the controller 34 also has a function included by the timing control section 22 according to Embodiments 1 to 6 of controlling the width of the gate pulse during the black writing period wider than the width of the gate pulse when display data is written. The same components as those in FIG. 15 are denoted by the same reference characters.

When a temperature is below a certain temperature, the timing control section 35 of the liquid crystal device according to Embodiment 10 controls ON/OFF of the backlight 11 and an output timing of a gate signal supplied by the gate driver 13 at the timings shown in FIG. 2 as those of the timing control section 22 of the liquid crystal display device according to Embodiment 1.

The certain temperature here means a temperature that does not cause transferring from the bend alignment to the spray alignment if only the black data to be inserted is written during the black writing period at timings shown in FIG. 2 and the black data is saved for periods shown in FIG. 2. The certain temperature here is a temperature corresponding to T₁ of FIG. 16.

When the timing control section 35 refers to the black insertion ratio table 25 and determines that the temperature of the liquid display panel 10 detected by the temperature sensor 18 is below a predetermined temperature (temperature corresponding to T₁ of FIG. 16) that does not cause transferring from the bend alignment to the spray alignment when it is controlled at timings shown in FIG. 2, it controls to write the data at predetermined timings shown in FIG. 2 (timings of Wu shown in FIG. 16) as a timing to write display data.

As shown in FIG. 2, as the width of the gate pulse to be generated when the black data is written during the black writing period is wider than that in the conventional art, the liquid crystal display element can be certainly charged to the black electric potential, transferring from the bend alignment to the spray alignment seldom occurs at the same temperature.

However, as shown in FIG. 32, because the required black insertion ratio increases as the temperature of the liquid crystal display panel increases, when it is controlled at such timings as in FIG. 2, occurrence transferring from the bend alignment to the spray alignment is prevented at temperatures higher than in the conventional art, but transferring from the bend alignment to the spray alignment occurs even in this case if a temperature further increases.

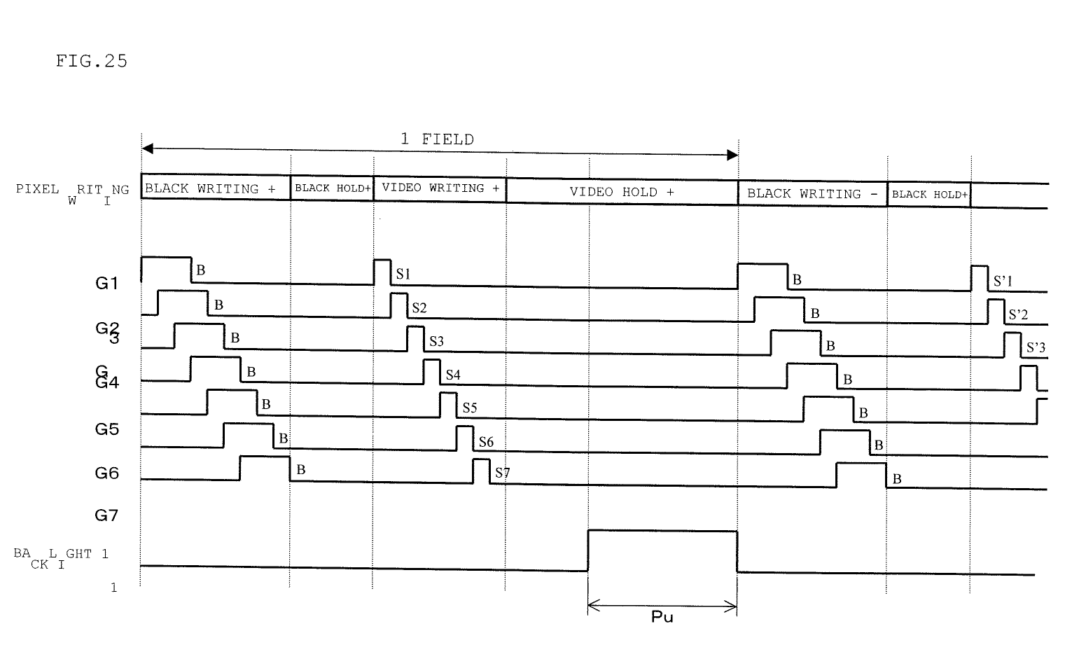

FIG. 25 shows a timing chart illustrating an operation for the liquid crystal display device according to Embodiment 10 to display a video at a high temperature. The high temperature here means a temperature at which transferring from the bend alignment to the spray alignment occurs due to lack of the saving timing of the black data when black data to be inserted and display data are written at the timings shown in FIG. 2.

Relation between the temperature of the liquid crystal display panel 10 and the timing available to start display data writing is the relationship as shown in FIG. 16 with a curve of the timing available to start display data writing 41 denoted by a dashed line being shifted to the right (toward higher temperatures) compared to Embodiment 7 by a bigger amount of the gate pulse in writing black data during the black writing period. As the gate pulse in the black data writing is increased, the upper limit temperature T₁ at which transferring from the bend alignment to the spray alignment is not caused at a predetermined display data writing timing Wu can be set to a temperature higher than that of Embodiment 7 in the case of Embodiment 10.

Then, the timing control section 35 decides the timing to decide starting of display data writing 42 from the timing available to start display data writing 41 obtained from the black insertion ratio table 25. When the temperature of the liquid crystal display panel 10 is the predetermined temperature T₁ or more, the timing to decide starting of display data writing 42 is decided as a timing after the timing available to start display data writing 41 as shown in FIG. 16.

When the temperature of the liquid crystal display panel 10 is over the predetermined temperature T₁ shown in FIG. 16, the timing control section 35 controls the display data writing start timing to be later than the case of FIG. 2 by providing the black HOLD period between the black writing period and the video writing period as shown in FIG. 25.

The black HOLD period as shown in FIG. 25 means a period by which the display data writing start timing becomes later than that in the case at the temperature less than T₁. As black data has been written in all the liquid crystal display elements during the black writing period shown in FIG. 25, all the gate lines are turned off during the black HOLD period.

Therefore, the length of the period during which a state of the black data is saved in each of the liquid crystal display elements at such a high temperature is as long as the black writing period+the black HOLD period and longer than the black writing period during which the temperature is less than T₁. Therefore, the black insertion ratio is also wider than that in the case of FIG. 2.

As such, in the liquid crystal display device of Embodiment 10, the occurrence transferring from the bend alignment to the spray alignment can be certainly prevented as it makes display data to be written in the liquid crystal display element at a timing at which the black insertion ratio increases by delaying the display data writing start timing at a high temperature.

As described above, the liquid crystal display device of Embodiment 10 can prevent transferring from the bend alignment to the spray alignment due to insufficient charging of the black data, which occurs at a certain temperature or below, and lowering of the contrast at a low temperature by increasing a gate pulse when the black data is written during the black writing period, and also prevents transferring from the bend alignment to the spray alignment due to lack of the saving time period of the black data which occurs at a high temperature.

The liquid crystal display device of Embodiment 10 can prevent transferring from the bend alignment to the spray alignment in all temperature ranges and implement display with a good contrast.

The timing control section 35 of the liquid crystal display device according to Embodiment 10 may include a function of the timing control section 26 of Embodiment 8 of controlling a timing to start lighting the backlight or may further include a function of the timing control section 28 according to Embodiment 9 of controlling brightness of the backlight according to the backlight lighting period where the backlight 11 is a LED backlight.

The timing control section 35 of the liquid crystal display device according to Embodiment 10 may include a function of the timing control section 22 according to Embodiments 4 to 6 of increasing the width of the gate pulse when the display data is written.

In each Embodiment, although data to be temporally stored in a frame memory is the data in an immediately previous field, the liquid crystal display device which displays the video by frame stores data in an immediately before frame. It is not limited to data in an immediately previous field or frame, and the liquid crystal display device may be adapted to store data in a plurality of fields or frames before to the immediately previous field or frame to sequentially display data in a plurality of fields or in a plurality of frames before.

A part of a function of the liquid crystal display device according to the present invention is made into a program below.

A program

used together with

a liquid crystal display device comprising:

a liquid crystal display panel having signal lines and scan lines arranged in a matrix and liquid crystal display elements using an OCB mode liquid crystal provided at intersection points between the signal lines and scan lines;

a frame memory which temporally stores display data for at least one immediately previous field or frame;

a gate driver which supplies a gate signal to the scan line;

wherein one field or one frame has in its period in order a black writing period, a display data writing period and a display data HOLD period;

a source driver which supplies a voltage corresponding to black data to the signal line during the black writing period, and supplies a voltage corresponding to the display data in a previous field or frame temporally stored in the frame memory to the signal line during the display data writing period;

a backlight arranged at the backside of the liquid crystal display panel for illuminating the liquid crystal display panel only during a backlight illuminating period, which is a part of the display data HOLD period during which the gate signal is kept not being turned on;

a temperature detecting unit for detecting a temperature of the liquid crystal display panel; and

a timing control unit for controlling, based on the detected temperature of the liquid crystal display panel, black data writing start timing for the source driver to start to supply to the signal line a voltage corresponding to the black data during the black writing period and display data writing start timing for the source driver to start to supply to the signal line a voltage corresponding to the display data during the display data writing period;

wherein, when the temperature of the liquid crystal display panel is a predetermined temperature or more, the timing control unit controls the display data writing start timing to gradually or stepwise delays more relative to the black data writing start timing as the temperature of the liquid crystal display panel is higher, and

the program causing a computer to function as

the timing control unit of the liquid crystal display device for controlling, based on the detected temperature of the liquid crystal display panel, black data writing start timing and display data writing start timing.

A program

used together with

a liquid crystal display device comprising:

a liquid crystal display panel having signal lines and scan lines arranged in a matrix and liquid crystal display elements using an OCB mode liquid crystal provided at intersection points between the signal lines and scan lines;

a frame memory which temporally stores display data for at least one immediately previous field or frame;

a gate driver which supplies a gate signal to the scan line;

wherein one field or one frame has in its period in order a black writing period, a display data writing period and a display data HOLD period;

a source driver which supplies a voltage corresponding to black data to the signal line during the black writing period, and supplies a voltage corresponding to the display data in a previous field or frame temporally stored in the frame memory to the signal line during the display data writing period;

a backlight arranged at the backside of the liquid crystal display panel for illuminating the liquid crystal display panel only during a backlight illuminating period, which is a part of the display data HOLD period during which the gate signal is kept not being turned on;

a temperature detecting unit for detecting a temperature of the liquid crystal display panel; and

a timing control unit for controlling, based on the detected temperature of the liquid crystal display panel, black data writing start timing for the source driver to start to supply to the signal line a voltage corresponding to the black data during the black writing period and display data writing start timing for the source driver to start to supply to the signal line a voltage corresponding to the display data during the display data writing period;

wherein, when the temperature of the liquid crystal display panel is a predetermined temperature or more, the timing control unit controls the display data writing start timing to gradually or stepwise delays more relative to the black data writing start timing as the temperature of the liquid crystal display panel is higher, and

the liquid crystal display further comprising:

a backlight control unit which controls the backlight to light only during the backlight illuminating period, and controls a timing to start lighting of a backlight gradually or stepwise delays more as the detected temperature of the liquid crystal display panel is higher when the temperature of the liquid crystal display panel is at the predetermined temperature or more and in a predetermined temperature range, and

the program causing a computer to function as

the backlight control unit of the liquid crystal display, which controls the backlight to light only during the backlight illuminating period, and controls a timing to start lighting of a backlight gradually or stepwise delays more as the detected temperature of the liquid crystal display panel is higher when the temperature of the liquid crystal display panel is at the predetermined temperature or more and in a predetermined temperature range.

A storage medium storing the program, which can be processed by a computer.

A program of the present invention operates in conjunction with a computer to cause the computer to execute a function of the timing control unit of the above mentioned liquid crystal display device of the present invention, for controlling, based on the detected temperature of the liquid crystal display panel, black data writing start timing and display data writing start timing.

A storage medium of the present invention stores a program for causing a computer to execute a function of the timing control unit of the above mentioned liquid crystal display device of the present invention, for controlling, based on the detected temperature of the liquid crystal display panel, black data writing start timing and display data writing start timing, the storage medium is computer readable and the read program is used in conjunction with the computer.

A function of the timing control unit of the present invention means all or a part of functions of the timing control unit.

A program of the present invention operates in conjunction with a computer to cause the computer to execute a function of the backlight control unit of the above mentioned liquid crystal display of the present invention, which controls the backlight to light only during the backlight illuminating period, and controls a timing to start lighting of a backlight gradually or stepwise delays more as the detected temperature of the liquid crystal display panel is higher when the temperature of the liquid crystal display panel is at the predetermined temperature or more and in a predetermined temperature range.

A storage medium of the present invention stores a program for causing a computer to execute a function of the backlight control unit of the above mentioned liquid crystal display of the present invention, which controls the backlight to light only during the backlight illuminating period, and controls a timing to start lighting of a backlight gradually or stepwise delays more as the detected temperature of the liquid crystal display panel is higher when the temperature of the liquid crystal display panel is at the predetermined temperature or more and in a predetermined temperature range, the storage medium is computer readable and the read program is used in conjunction with the computer.

The function of the backlight control unit of the present invention means all or a part of the functions of the backlight control unit.

A usage of the program of the present invention may be an aspect to be stored in a computer readable storage medium and operates in conjunction with the computer.

As a storage medium, a ROM or the like may be included.

The above mentioned computer of the present invention is not limited to pure hardware such as a CPU and may include firmware, an OS, and further a peripheral appliance.

As mentioned above, a configuration of the present invention may be implemented in software or in hardware.

As a liquid crystal display device according to the present invention and a method for driving the liquid crystal display device have effects of reducing insufficient writing to the liquid crystal display element when a voltage corresponding to black data to be inserted for preventing transferring from the bend alignment to the spray alignment is supplied in a method for causing a backlight to illuminate only while a liquid crystal display element responds to display data, it is useful in the liquid crystal device using an OCB mode liquid crystal and a method for driving the liquid crystal display device.

As another liquid crystal display device according to the present invention and a method for driving the liquid crystal display device have effects of preventing occurrence transferring from the bend alignment to the spray alignment even at a high temperature in a method for causing a backlight to illuminate only while a liquid crystal display element responds to the display data, it is useful in the liquid crystal display device using an OCB mode liquid crystal and a method for driving the liquid crystal display device.

What is claimed is:

1. A liquid crystal display device comprising:
a liquid crystal display panel having signal lines and scan lines arranged in a matrix and liquid crystal display elements using an OCB mode liquid crystal provided at intersection points between said signal lines and scan lines;
a frame memory which temporally stores display data for at least one immediately previous field or frame;
a gate driver which supplies a gate signal to said scan line;
wherein one field or one frame has in its period, in order, a black writing period, a display data writing period and a display data hold period;
a source driver which supplies a voltage corresponding to black data to said signal line during said black writing period, and supplies a voltage corresponding to the display data in a previous field or frame temporally stored in said frame memory to said signal line during said display data writing period; and
a backlight arranged at the backside of said liquid crystal display panel for illuminating said liquid crystal display panel only during a part of said display data hold period during which said gate signal is kept turned off; wherein
said gate driver operates so that when said source driver supplies a voltage corresponding to said black data during said black writing period, a period during which each of said gate signals to be supplied to each of said scan lines is turned on is longer than one line writing period during which said source driver writes display data for one line.

2. The liquid crystal display device according to claim 1, wherein
the period during which said gate driver turns on each of said gate signals to be supplied to each of said scan lines when said source driver supplies a voltage corresponding to said black data during said black writing period is a period during which said liquid crystal display element can be charged to at least a predetermined voltage value required to avoid transferring from the bend alignment to the spray alignment; and
said gate driver sequentially turns on each of said gate signals of each of said scan lines during said black writing period so that a period after a voltage corresponding to said black data is supplied during said black writing period for each of the liquid crystal display elements until a voltage corresponding to said display data is supplied during said display data writing period is sufficient for said liquid crystal display element to be charged to a predetermined voltage to execute black insertion and also at least a predetermined period during which transferring from the bend alignment to the spray alignment does not occur to any of said liquid crystal display element.

3. The liquid crystal display device according to claim 1, wherein
the period during which said gate driver turns on each of said gate signals to be supplied to each of said scan lines when said source driver supplies a voltage corresponding to said black data during said black writing period is a period during which said liquid crystal display element can be charged to at least a predetermined voltage value required to avoid transferring from the bend alignment to the spray alignment; and
said gate driver turns on each of said gate singles of each of said scan lines during said black writing period at a time so that a period after a voltage corresponding to said black data is supplied to each of said liquid crystal display elements during said black writing period until a voltage corresponding to said display data is supplied to each of said liquid crystal display elements during said display data writing period is sufficient for said liquid crystal display element to be charged to a predetermined voltage to execute black insertion and also at least a predetermined period during which transferring from the bend alignment to the spray alignment does not occur to any of said liquid crystal display element.

4. The liquid crystal display device according to claim 1, wherein
said gate driver operates so that a period during which it turns on each of said gates signals to be supplied to each of said scan lines during said black writing period is longer than said period during which it turns on each of said gate signals to be supplied to each of said scan lines when a voltage corresponding to said display data is supplied, only in the case where a polarity of a voltage supplied by said source driver corresponding to said black data during said black writing period is reversed from a polarity of a voltage supplied by said source driver in association with said display data during said display data wring period immediately therebefore.

5. The liquid crystal display device according to claim 1, wherein
said gate driver supplies each of said gate signals so that the total of the periods during which each of said gate signals for each of said scan lines is turned on in said display data writing period provided in a period of said one field or one frame is longer than said one line writing period.

6. The liquid crystal display device according to claim 5, wherein
said gate driver turns on each of said gate signals to be supplied to each of said scan lines once for said display data writing period provided in a period of said one field or one frame; and
said period during which each of said gate signals is turned on once is longer than said one line writing period.

7. The liquid crystal display device according to claim 5, wherein
said gate driver executes an operation for sequentially turning on each of said gate signals to be supplied to each of said scan lines for a plurality of times during said display data writing period provided in a period of said one field or frame; and
any one period among those during which each of said gate signals is turned on for a plurality of times is longer than said one line writing period or longer.

8. The liquid crystal display device according to claim 7, wherein
during said display data writing period provided in a period of said one field or frame, a period during which said gate driver turns on each of said gate signals for the last time among a plurality of periods during which each of said gate signals to be supplied to each of said scan lines is turned on is as long as said one line writing period.

9. The liquid crystal display device according to claim 7, wherein
said source driver supplies a voltage corresponding to the same display data for each line to said signal lines for a plurality of times in each period during which said gate driver turns on each of said gate signals for a plurality of times during said display data writing period provided in a period of said one field or frame.

10. A method for driving a liquid crystal display device, wherein said liquid crystal display device comprises:
a liquid crystal display panel having signal lines and scan lines arranged in a matrix and liquid crystal display elements using an OCB mode liquid crystal provided at intersection points between said signal lines and scan lines;
a frame memory which temporally stores display data for at least one immediately previous field or frame;
a gate driver which supplies a gate signal to said scan line;
wherein one field or one frame has in its period, in order, a black writing period, a display data writing period and a display data hold period;
a source driver which supplies a voltage corresponding to black data to said signals line during said black writing period, and supplies a voltage corresponding to the display data in a previous field or frame temporally stored in said frame memory to said signal line during said display data writing period; and
a backlight arranged at the backside of said liquid crystal display panel for illuminating said liquid crystal display panel only during a part of said display data hold period during which said gate signal is kept turned off; wherein
when said source driver supplies a voltage corresponding to said black data during said black writing period, a period during which each of said gate signals to be supplied to each of said scan lines is turned on is longer than a period during which said source driver writes display data for one line.

11. A liquid crystal display device comprising:
a liquid crystal display panel having signal lines and scan lines arranged in a matrix and liquid crystal display elements using an OCB mode liquid crystal provided at intersection points between said signal lines and scan lines;
a frame memory which temporally stores display data for at least one immediately previous field or frame;
a gate driver which supplies a gate signal to said scan line;
wherein one field or one frame has in its period, in order, a black writing period, a display data writing period and a display data hold period;
a source driver which supplies a voltage corresponding to black data to said signal line during said black writing period, and supplies a voltage corresponding to the display data in a previous field or frame temporally stored in said frame memory to said signal line during said display data writing period;
a backlight arranged at the backside of said liquid crystal display panel for illuminating said liquid crystal display panel only during a backlight illuminating period, which is a part of said display data hold period during which said gate signal is kept turned off;
a temperature detecting unit for detecting a temperature of said liquid crystal display panel; and
a timing control unit for controlling, based on the detected temperature of said liquid crystal display panel, black data writing start timing for said source driver to start to supply to said signal line a voltage corresponding to said black data during said black writing period and display data writing start timing for said source driver to start to supply to said signal line a voltage corresponding to said display data during said display data writing period;
wherein, when the temperature of said liquid crystal display panel is a predetermined temperature or more, said timing control unit controls said display data writing start timing to gradually or stepwise delays more relative to said black data writing start timing as the temperature of said liquid crystal display panel is higher.

12. The liquid crystal display device according to claim 11, wherein
a period during which said black data is written in and saved in each of said liquid crystal display elements when said timing control unit controls said display data writing start timing is a period during which transferring from the bend alignment to the spray alignment does not occur.

13. The liquid crystal display device according to claim 11, comprising:
a black insertion ratio table in which a temperature of said liquid crystal display panel and an insertion ratio of said black data required to prevent transferring from the bend alignment to the spray alignment from being occurred at each temperature are associated with each other; wherein
said timing control unit obtains an insertion ratio of said black data required at the detected temperature of said liquid crystal display panel by referring to said black insertion ratio table and decides said display data writing start timing from said obtained insertion ratio.

14. The liquid crystal display device according to claim 11, further comprising:
a backlight control unit which controls said backlight to light only during said backlight illuminating period, and controls a timing to start lighting of a backlight to gradually or stepwise delay more as the detected temperature of said liquid crystal display panel is higher when the temperature of said liquid crystal display panel is at said predetermined temperature or more and in a predetermined temperature range.

15. The liquid crystal display data according to claim 14, wherein
said backlight control unit makes said timing to start lighting of a backlight a predetermined lighting timing which is decided in advance when the detected temperature of said liquid crystal display panel is lower than a temperature in said predetermined temperature range.

16. The liquid crystal display device according to claim 14, comprising:
a lighting start timing decision table which associates a temperature of said liquid crystal display panel and a timing to start lighting of said backlight required at the temperature; wherein
said backlight control unit obtains said timing to start lighting of a backlight required at the detected temperature of said liquid crystal display panel by using said lighting start timing decision table and starts lighting of said backlight after said obtained timing to start lighting of a backlight.

17. The liquid crystal display device according to claim 16, wherein
said timing to start lighting of a backlight required at said temperature is a timing at which a response voltage value of all of said liquid crystal display elements are 90% or more after a voltage corresponding to said display data is supplied to said signal lines.

18. The liquid crystal display device according to claim 14, wherein
said backlight is a LED, and
said backlight control unit controls a current of said backlight to increase so that the backlight lights brighter when said timing to start lighting of a backlight delays.

19. The liquid crystal display device according to claim 18, wherein
said backlight control unit controls an applied voltage to said backlight to increase so that the current of the backlight increases.

20. A method for driving a liquid crystal display device, wherein said liquid crystal display device comprises:
a liquid crystal display panel having signal lines and scan lines arranged in a matrix and liquid crystal display elements using an OCB mode liquid crystal provided at intersection points between said signal lines and scan lines;
a frame memory which temporally stores display data for at least one immediately previous field or frame;
a gate driver which supplies a gate signal to said scan line;
wherein one field or one frame has in its period, in order, a black writing period, a display data writing period and a display data hold period;
a source driver which supplies a voltage corresponding to black data to said signal line during a black writing period, and supplies a voltage corresponding to the display data in a previous field or frame temporally stored in said frame memory to said signal line during said display data writing period;
a backlight arranged at the backside of said liquid crystal display panel for illuminating said liquid crystal display panel only during a backlight illuminating period, which is a part of said display data hold period during which said gate signal is kept turned off; and
a temperature detecting unit for detecting a temperature of said liquid crystal display panel; wherein
black data writing start timing for said source driver to start to supply to said signal line a voltage corresponding to said black data during said black writing period and display data writing start timing for said source driver to start to supply to said signal line a voltage corresponding to said display data during said display data writing period are controlled based on the detected temperature of said liquid crystal display panel,
wherein, when the temperature of said liquid crystal display panel is a predetermined temperature or more, said display data writing start timing is controlled to gradually or stepwise delay more relative to said black data writing start timing as the temperature of said liquid crystal display panel is higher.
